(19) United States
(12) Patent Application Publication
(10) Pub. No.: US 2017/0045690 A1
(43) Pub. Date: Feb. 16, 2017

(54) OPTICAL SCRAMBLERS

(71) Applicant: The Penn State Research Foundation, University Park, PA (US)

(72) Inventors: Suvrath Mahadevan, State College, PA (US); Arpita Roy, State College, PA (US); Sam Halverson, State College, PA (US)

(21) Appl. No.: 15/234,465

(22) Filed: Aug. 11, 2016

Related U.S. Application Data
(60) Provisional application No. 62/204,206, filed on Aug. 12, 2015.

(51) Int. Cl. G02B 6/32; G01J 3/02; G02B 6/36

(52) U.S. Cl. CPC G02B 6/32; G02B 6/3652; G01J 3/0218; G01J 3/0208

(57) ABSTRACT

The disclosure features optical scramblers that can be used with spectrographs and other optical measurement systems, including Doppler-based radial velocity measurement systems and other precision spectroscopy. In one aspect, an optical scrambler includes a first fiber configured to receive measured light from an optical collection system, a second fiber configured to deliver the measured light to a detection system, and an optical coupling element positioned between a light output surface of the first fiber and a light input surface of the second fiber and configured to deliver the measured light from the first fiber to the second fiber. The coupling element defines an output focal position for the measured light that is delivered to the second fiber and the output focal position is located within 50 microns of an output surface of the coupling element.

### CROSS-REFERENCE TO RELATED APPLICATIONS

This application claims priority to U.S. Provisional Patent Application No. 62/204,206, filed on Aug. 12, 2015, the entire contents of which are incorporated herein by reference.

### STATEMENT AS TO FEDERALLY SPONSORED RESEARCH

This invention was made with Government support grant numbers AST1006676, AST1126413, and AST1310885, awarded by the National Science Foundation. The Government has certain rights in the invention.

### TECHNICAL FIELD

This disclosure relates to optical scramblers, including optical scramblers for use in spectral radial velocity measurement systems and other precision spectroscopic measurement systems.

### BACKGROUND

Detecting extrasolar planetary Earth analogs via radial velocity measurements has proved to be challenging, in part due to the levels of Doppler precision that are expected to be required to detect such planets. The expected radial velocity (RV) amplitude of an earth-size planet orbiting in the habitable-zone of a Sun-like star is ˜10 cm s⁻¹, beyond the precision generally achievable with the current generation of dedicated Doppler spectrographs. One of the major technical challenges in improving the stability of these instruments is stabilizing the instrument illumination. Conventional slit-fed spectrographs have instrument point-spread functions (PSF) that vary significantly with seeing conditions and telescope guiding variability, thus limiting their ultimate RV precision. Consequently, these instruments typically require specialized methods of simultaneous calibration and data reduction to retrospectively discern stellar radial velocity signals from instrument illumination variations.

Optical fibers offer a convenient and efficient method of transporting light from telescopes, allowing instruments to be physically decoupled from the telescope focus. While the addition of a conventional circular fiber provides a significant improvement in instrument PSF stability, the output of a typical astronomical fiber is still sensitive to the flux distribution incident on the fiber from the telescope. As this input illumination varies (e.g., due to guiding errors, seeing, or telescope pupil variations), the output intensity distribution also varies. This is particularly an issue for fiber-fed Doppler RV instruments since illumination variations in the fiber output can directly manifest as changes in the instrument profile. This effect generally cannot be compensated with standard emission wavelength references that use a dedicated calibration fiber, since the output illumination is specific to the fiber and source and thus the calibration source typically does not accurately trace any variations in the stellar illumination propagating through the object fiber. As a result, spectrograph illumination is currently a precision-limiting factor in Doppler spectroscopy, along with source stability and wavelength calibration.

### SUMMARY

This disclosure features optical scramblers that can be used with spectrographs and other optical measurement systems, including Doppler-based radial velocity measurement systems and other precision spectroscopy. The scramblers typically include an optical element that couples light from a first fiber into a second fiber. The properties of the optical element are selected so that sensitivity to alignment errors among components of the optical element is reduced, relative to conventional fiber coupling systems.

In general, one innovative aspect of the subject matter described in this disclosure features an optical scrambler that includes a first fiber configured to receive measured light from an optical collection system, a second fiber configured to deliver the measured light to a detection system, and an optical coupling element positioned between a light output surface of the first fiber and a light input surface of the second fiber and configured to deliver the measured light from the first fiber to the second fiber. The coupling element defines an output focal position for the measured light that is delivered to the second fiber and the output focal position is located within 50 microns, e.g., 20 microns or less, of an output surface of the coupling element.

The foregoing and other embodiments can each optionally include one or more of the following features, alone or in combination. For instance, the output surface of the coupling element can have a spherical shape that defines the output focal position. The output focal position can be at the output surface of the optical coupling element. A radius of the output surface can be determined based on one or more parameters of the first fiber including a core diameter and numerical aperture. In some examples, the radius of the output surface is determined based on:

$$r = \frac{d ( n - 1 )}{n} \sqrt{\frac{1}{{NA}^{2} - 1}} ,$$

where r represents the radius, n represents the refractive index of a material forming the coupling element, and d and NA represent the core diameter and the numerical aperture of the first fiber, respectively.

In some examples, the light input surface of the second fiber is within 50 microns of the output focal position, e.g., within 20 microns of the output focal position. The light input surface of the second fiber can be at the output focal position. In a particular example, the light input surface of the second fiber is positioned in contact with the output surface of the coupling element. In some examples, the coupling element has an input surface with a spherical shape that defines an input focal position. The light output surface of the first fiber can be within 50 microns of the input focal position, e.g., within 20 microns of the input focal position. In a particular example, the light output surface of the first fiber is at the input focal position. The light output surface of the first fiber can be positioned in contact with an input surface of the coupling element.

The coupling element can include a cylindrical body having end surfaces with spherical curvature. In some cases, the output surface of the coupling element can also have an aspherical curvature.

In some implementations, the coupling element includes a ball lens. In some examples, the coupling element is formed from a material having a refractive index of between 1.9 and 2.1 for at least one wavelength within a range from 800 nm to 1300 nm. The light input surface of the second fiber can be within 50 microns of the output focal position. The light output surface of the first fiber can be within 50 microns of the input focal position. In a particular example, the material has a refractive index of between 1.95 and 2.05 for at least one wavelength within the range from 800 nm to 1300 nm. The light input surface of the second fiber can be within 20 microns of the output focal position. The light output surface of the first fiber can be within 20 microns of the input focal position. In some examples, the coupling element is formed from a material having a refractive index of between 1.9 and 2.1 for at least one wavelength within a range from 400 nm to 900 nm. The light input surface of the second fiber can be within 50 microns of the output focal position. The light output surface of the first fiber can be within 50 microns of the input focal position. In a particular example, the material has a refractive index of between 1.95 and 2.05 for at least one wavelength within the range from 400 nm to 900 nm. The light input surface of the second fiber can be within 20 microns of the output focal position. The light output surface of the first fiber can be within 20 microns of the input focal position.

The first fiber can be a multimode fiber with a core diameter within 50 microns to 1000 microns. The first fiber can have an octagonal cross-sectional shape. The first fiber can also have a circular cross-sectional shape. In some cases, the light output surface of the first fiber is planar. In some cases, the coupling element comprises an input surface through which the measured light enters the coupling element, and the light output surface of the first fiber is nonplanar and has a shape that conforms to the input surface of the coupling element.

The second fiber can be a multimode fiber with a core diameter within 50 microns to 1000 microns. The second fiber can have an octagonal cross-sectional shape. The second fiber can also have a circular cross-sectional shape. The light input surface of the second fiber can be planar. The light input surface of the second fiber can be also nonplanar and have a shape that conforms to the output surface of the coupling element.

In some implementations, the optical scrambler further includes a third fiber optically coupled to at least one of the first fiber and the second fiber. The first and second fibers each can have an octagonal cross-sectional shape and the third fiber has a circular cross-sectional shape.

In some implementations, the optical scrambler further includes a mounting apparatus comprising at least one channel configured to support the first fiber, the coupling element, and the second fiber to maintain a fixed spacing between the first and second fibers and the coupling element. The mounting apparatus can include a groove mounting block fabricated using a 3D printing or Stereolithographic system. In some examples, the optical scrambler includes a mounting block comprising a plurality of groove channels each configured to support a respective first fiber, a respective coupling element, and a respective second fiber to maintain a respective fixed spacing between the respective first and second fibers and the respective coupling element. The plurality of groove channels can be parallel to each other.

In some implementations, the optical scrambler further includes a first fiber connector coupled to an end of the first fiber comprising the light output surface of the first fiber, and a second fiber connector coupled to an end of the second fiber comprising the light input surface of the second fiber, and the coupling element is positioned between the first fiber connector and the second fiber connector.

Central axes of the first fiber, the coupling element and the second fiber can be aligned within a tolerance of 10 microns in a direction perpendicular to the central axes when the first and second fibers and the coupling element are supported by a mounting apparatus.

The optical scrambler can further include an anti-reflection coating on the output surface of the coupling element. In some examples, during operation, the optical scrambler provides a scrambling gain of 10,000 or more for the measured light.

Another innovative aspect of the subject matter described in this disclosure features a radial velocity measurement system including an optical collection system for collecting light from a moving object, a detection system, and the optical scrambler as described above.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more implementations are set forth in the accompanying drawings and the description below. Other features and advantages will be apparent from the description, drawings, and claims.

### DESCRIPTION OF DRAWINGS

FIG. 1A is a schematic diagram of an embodiment of a system including an optical scrambler.

FIG. 1B shows a sectional view of the optical scrambler of FIG. 1A.

FIG. 2 is a schematic diagram of an optical scrambler that includes a ball lens.

FIG. 3 shows theoretical guiding-induced velocity errors as a function of near-field scrambling gain for the Habitable Zone Planet Finder (HPF).

FIGS. 4A-B show refractive index profiles as a function of wavelength for a variety of high-index glasses in the visible (FIG. 4A) and near-infrared (FIG. 4B).

FIG. 5A shows a schematic diagram of an example mounting apparatus for an optical scrambler based on FC connectors.

FIG. 5B shows an image of an assembled ball lens double scrambler with octagonal fiber cables on either side.

FIG. 6 is an image showing another example mounting apparatus that includes a grooved mounting block.

FIG. 7A is a schematic diagram of an optical scrambling measurement apparatus.

FIG. 7B is an image showing the scrambling gain measurement apparatus of FIG. 7A.

FIG. 8 is a graph showing measured near-field centroid drift as a function of time for light output from a test fiber.

FIG. 9 is a schematic diagram illustrating a scrambling measurement method.

FIGS. 10A-10E are plots showing near-field scrambling measurements for optical scramblers with different fiber configurations.

FIGS. 11A-11E are plots showing far-field scrambling measurements corresponding to the different fiber configurations of FIGS. 10A-10E.

FIGS. 12A-12B are plots showing measured far-field output from a single circular fiber (FIG. 12A) and an optical scrambler that includes two octagonal fibers and a ball lens, coupled to a circular fiber (FIG. 12B).

FIG. 13A shows a schematic ray tracing diagram showing light propagation within a ball lens.

FIG. 13B shows a series of spot diagrams corresponding to different input field points in FIG. 13A.

FIG. 14 is a graph showing simulated optical transmission as a function of wavelength for an embodiment of an optical scrambler.

FIG. 15 is a schematic diagram showing an example of an interstellar spectroscopic measurement system that includes an optical scrambler.

FIG. 16 is a schematic diagram showing an optical scrambler including a number of grooves integrated on a mounting block.

Like reference symbols in the various drawings indicate like elements.

### DETAILED DESCRIPTION

### Introduction

High precision spectroscopic measurement systems are often used to conduct sensitive, low-light measurements such as galactic and extra-galactic planetary surveys and other astrophysical investigations at visible and/or near-infrared wavelengths. Many such systems perform Doppler-based radial velocity measurements in an effort to reliably identify targets at great distances from these Earth-based systems. The Habitable-zone Planet Finder spectrograph is one example of such a system.

In these high precision systems, step-index multimode fibers have been used as optical image scramblers to decouple the distribution of flux in an output beam from an illumination pattern at a telescope focal plane. In agreement with theory, repeated laboratory tests show that standard circular fibers yield a high degree of azimuthal scrambling, but minimal radial scrambling. Fibers with non-circular cores have demonstrated improvement over standard circular core fibers.

However, single non-circular core fibers generally cannot deliver the kind of homogeneity, in both near and far-field, that is typically required by spectrographs for performing high-precision RV measurements below the 1 m s⁻¹ level. To perform highly sensitive measurements at relatively slow radial velocities, spectroscopic measurement systems rely on high levels of optical scrambling in both the near and far fields of the beam, without significantly compromising overall throughput.

As used herein, a fiber's “near field” light distribution is defined as the positional light intensity distribution across the fiber's input surface, and the fiber's “far field” light distribution is defined as the angular light distribution at the fiber's output surface. In Doppler-based measurement systems, the fiber's near field is typically re-imaged at a spectrograph focal plane. Any variations in the near-field light distribution will therefore generally manifest as PSF variations, degrading overall instrument stability and measurement precision.

The far-field pattern is projected onto the grating, and time-varying inhomogeneities that change groove illumination can introduce variable wavelength shifts at the detector. Changes in the far field also affect the illumination of the detector and other spectrograph optics, and therefore can change the contribution of aberrations to the point spread function (PSF)shape, causing velocity shifts of spectral lines on the detector. Spurious profile changes in the spectra generally diminish RV precision. Accordingly, stabilizing both the near-field and far-field light intensity distributions of the fiber that delivers light to the spectrograph is an important aspect of making high precision Doppler-based spectroscopic measurements.

### Optical Scrambling

The near-field and far-field light intensity distributions can be stabilized by optically scrambling the light. In the context of this disclosure, “optical scrambling” refers to re-orienting the wavevectors of light photons such that the near-field and far-field light intensity distributions are de-correlated from one another. As a practical matter, complete de-correlation between the light intensity distributions is typically not achieved. However, as the extent of optical scrambling increases, the correlation between the near- and far-field distributions is reduced, and therefore the stability of the distributions is increased. The extent of optical scrambling can be measured by the “scrambling gain” of a scrambling element or system, as will be discussed in greater detail below.

In the context of the present disclosure, optical scrambling differs from fiber speckle noise, also called “modal noise”, which is due to the time-dependent variation of the speckle pattern produced by the finite number traversing modes within a multi-mode fiber interfering at the fiber exit boundary. Scrambling corresponds to the de-correlation of fiber output illumination from input variations (or a re-arrangement of existing modes), and is a static correction that does not account for the time variation of modal power and phase distribution between exposures caused by the changing internal geometry of light rays. Proper modal noise mitigation generally involves a temporal redistribution of modes, commonly achieved through physical agitation of the fiber. This forces the light to populate different modes (including unpopulated ones) with a large distribution of phases, and reduces modal noise by varying the number and phase distribution of modes per exposure.

While poor scrambling changes the shape of the instrument profile and can shift its centroid, the effect of modal noise is to introduce systematic uncertainty in the instrument profile over time. Both are detrimental to high-precision radial velocity measurements but are different phenomena that do not have a single solution. Unlike scrambling, modal noise mitigation typically involves a time-varying correction that is not provided by static fibers or the presence of an optical scrambler alone.

In some implementations, the scrambling gain in a spectroscopic measurement system between the near- and far-fields can be increased by introducing an optical scrambler into the instrument fiber delivery system that exchanges the near and far fields using a lens relay. Coupling octagonal fibers on either side of an optical scrambler increases the scrambling gain, thereby stabilizing both the near- and far-field illumination patterns.

This disclosure features optical scramblers (implemented, in some implementations, as optical fiber double scramblers) that include a high refractive index optical element with spherical surfaces, such as a ball lens. When the high refractive index ball lens is used to couple light between fibers having octagonal cross-sectional core shapes, the optical scramblers disclosed herein can achieve scrambling gains in excess of 10,000, and efficiencies of up to 87% in the NIR region of the spectrum, which is close to the theoretical maximum efficiency. Addition of a fiber with a circular cross-sectional core shape to the optical scramblers can increase the scrambling gain to >20,000, which is significantly larger than scrambling gains achieved in conventional optical scramblers. This translates to roughly 10 cm s⁻¹ velocity error for a Habitable-zone Planet Finder (HPF) instrument due to telescope guiding error, significantly less than the 30 cm s⁻¹ guiding-induced velocity measurement error that is used as a benchmark for extra-solar planet detection.

The optical scramblers disclosed herein can be fabricated using many off-the-shelf components to reduce costs, and can therefore take advantage of existing high-tolerance components used in commercial telecommunications industries. The scramblers can be customized for operation in the NIR (0.82-1.3 μm) and visible wavelengths (380-900 nm) by using different high-index glasses to form the optical coupling element (e.g., the ball lens). In some implementations, the scramblers can be aligned with optical fibers using alignment apparatus printed using a three-dimensional (3D) printer or a Stereolithographic system to accommodate higher precision tolerances and customization

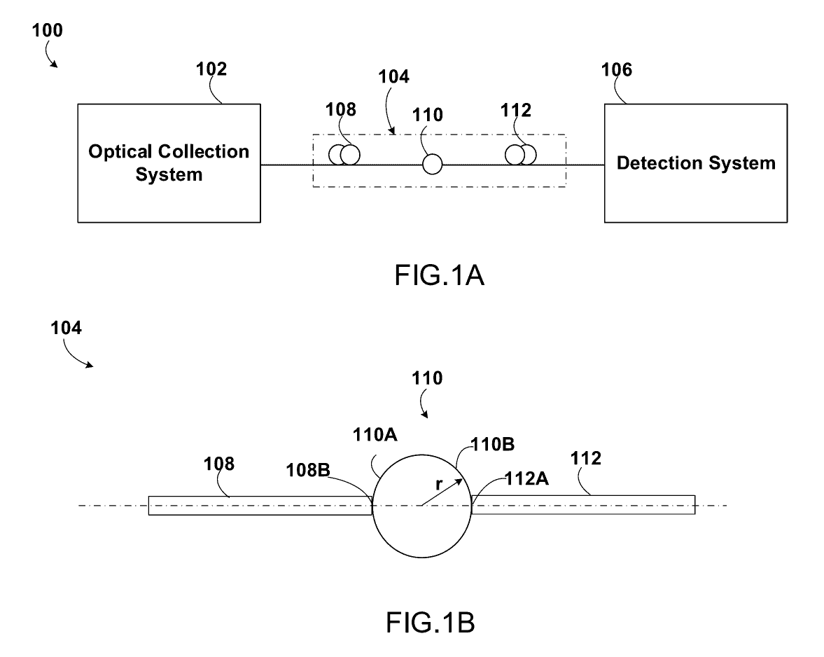

FIG. 1A is a schematic diagram of an embodiment of a spectroscopic measurement system 100, which includes an optical collection system 102, an optical scrambler 104, and a detection system 106. As an example, system 100 can correspond to a radial velocity measurement system, e.g., the Habitable-zone Planet Finder, that utilizes a highly stable and homogeneous illumination pattern at an output fiber surface that is coupled into detection system 106.

The optical collection system 102 is configured to collect light from an object. For example, in some implementations, the optical collection system 102 includes a telescope for collecting light from stars and other celestial objects. The detection system 106 receives collected light and analyzes the light. In certain implementations, for example, detection system 106 includes a spectrograph to obtain one or more images of collected light that passes through optical scrambler 104.

The optical scrambler 104 is configured to scramble the collected light and improve illumination stability. By scrambling the collected light, the optical scrambler 104 at least partially decouples the spatial light distribution at a focal plane of the optical collection system 102 (e.g., at the focal plane of a telescope in optical collection system 102) from the spatial light distribution at a focal plane of the detection system 106 (e.g., at the entrance pupil of a spectrograph in detection system 106). By decoupling these spatial light distributions, the effect of variations in the spatial light distribution at the focal plane of the optical collection system 102 that are due, for example, to atmospheric variations and/or imperfect telescope guiding and tracking of objects being observed, are reduced at the focal plane of the detection system 106.

In some implementations, the optical scrambler 104 includes an input optical fiber 108, an optical coupling element 110, and an output optical fiber 112. The input optical fiber 108 is configured to receive light from the optical collection system 102, and the output optical fiber 112 is configured to deliver the measured light to the detection system 106. The optical coupling element 110 is configured to deliver the measured light from the input optical fiber 108 to the output optical fiber 112. In some implementations, the optical scrambler 104 is used for optical systems other than fiber-fed systems. For example, the coupling element in the optical scrambler 104 can be coupled to any suitable optical elements, e.g., optical waveguides, and configured to deliver light from an input optical element, e.g., an input waveguide, to an output optical element, e.g., an output waveguide.

FIG. 1B shows a sectional view of the optical scrambler 104 of FIG. 1A. The optical coupling element 110 is positioned between a light output surface 108B of the input optical fiber 108 and a light input surface 112A of the output optical fiber 112. The optical coupling element 110 includes an input surface 110A and an output surface 110B.

The shape of output surface 110B, together with the material(s) from which coupling element 110 is fabricated, defines an output focal position between coupling element 110 and output optical fiber 112 for the measured light that is delivered to the output optical fiber 112. In general, output surface 110B can have a surface curvature that corresponds to a variety of different shapes. For example, in some implementations, output surface 110B is a spherical surface (e.g., having spherical curvature of radius r). More generally, output surface 110B can have a more complex surface curvature (e.g., an aspherical surface shape) to define the output focal position.

When the output focal position defined by output surface 110B is too far from surface 110B, positioning output optical fiber 112 correctly—and maintaining a precise fiber position relative to surface 110B while measurements are performed—is challenging. Even relatively small variations in the position of fiber 112 relative to the output focal position can influence measurement results. Accordingly, in some implementations, output surface 110B of coupling element 110 is shaped so that the output focal position is located within 50 microns or less of the output surface 110B (e.g., within 20 microns or less, within 15 microns or less, within 10 microns or less, within 5 microns or less, within 3 microns or less). In certain implementations, the output focal position is located on the output surface 110B (e.g., at the position of the optical axis in FIG. 1B).

To further reduce demanding alignment requirements between coupling element 110 and output optical fiber 112, in some implementations the light input surface 112A of the output fiber 112 is positioned within 50 microns or less (e.g., within 20 microns or less, within 15 microns or less, within 10 microns or less, within 5 microns or less, within 3 microns or less) of the output focal position. In certain implementations, light input surface 112A is positioned at the output focal position. For example, alignment requirements between coupling element 110 and output optical fiber 112 can be significantly alleviated in implementations where the output focal position is located on the output surface 110B (e.g., at the position of intersection of the optical axis in FIG. 1B and output surface 110B), and the light input surface 112A of the output optical fiber 112 is also positioned at the output focal position, in contact with the output surface 110B.

In general, the input surface 110A of the coupling element 110, along with the material(s) from which coupling element 110 is fabricated, define an input focal position between input optical fiber 108 and coupling element 110. In some implementations, input surface 110A has a spherical shape (e.g., spherical curvature of radius r). More generally, input surface 110A can have a more complex shape (e.g., an aspherical curvature) that defines the input focal position.

When the input focal position defined by input surface 110A is positioned too far from surface 110A, alignment requirements between input optical fiber 108 and coupling element 110 can be demanding to satisfy and maintain as measurements are performed. Accordingly, in some implementations, input surface 110A is shaped so that the input focal position is located within 50 microns or less of input surface 110A (e.g., within 20 microns or less, within 15 microns or less, within 10 microns or less, within 5 microns or less, within 3 microns or less). In certain implementations, the input focal position is located on the input surface 110A (e.g., at the intersection of input surface 110A and the optical axis in FIG. 1B).

To further reduce demanding alignment requirements between coupling element 110 and input optical fiber 108, in some implementations the light output surface 108B of the input fiber 108 can be positioned within 50 microns or less of the input focal position (e.g., within 20 microns or less, within 15 microns or less, within 10 microns or less, within 5 microns or less, within 3 microns or less). In certain implementations, the light output surface 108B is located at the input focal position. For example, alignment requirements between light input fiber 108 and coupling element 110 can be significantly alleviated in implementations where the input focal position is located on input surface 110A of coupling element 110, and the output surface 108B of the input fiber 108 is also positioned at the input focal position, in contact with surface 110A. As noted above, this alignment can be achieved with precision mounting apparatus, e.g., groove mounting blocks fabricated by using modern 3D printing or Stereolithographic systems for high tolerance. In some implementations, the input optical fiber 108 has a relatively large core diameter, e.g., 300 micron, which can reduce the alignment requirements between coupling element 110 and the input optical fiber 108.

The size (e.g., defined by an actual or effective core diameter d) of the input fiber 108 is typically determined by user requirements. For example, for astronomical instruments, the size of the input fiber 108 can depend on the location of the telescope in optical collection system 102 and the climate and weather conditions under which observations will be performed. In general, the size of input fiber 108 is selected so that input fiber 108 is large enough to collect light from objects of interest, but not so large that significant extra background light is also collected.

In some implementations, input fiber 108 is a multimode fiber having a single fiber core with a circular cross-sectional shape. The core diameter can be within a range from 50 microns to 1000 microns (e.g., within a range from 100 microns to 1000 microns, within a range from 100 microns to 500 microns).

More generally, input fiber 108 can have a fiber core with a variety of different cross-sectional shapes. In certain implementations, input fiber 108 can have a fiber core with an octagonal cross-sectional shape, an elliptical cross-sectional shape, a square cross-sectional shape, a rectangular cross-sectional shape, a hexagonal cross-sectional shape, or any other cross-sectional shape. In a particular example, the input fiber 108 can have a core with an octagonal cross-sectional shape (an “octagonal fiber”), and a core diameter of 300 μm, which can be fed at f/3.65 at the focal plane of the optical collection system 102.

In some implementations, input fiber 108 can include multiple fiber cores. For example, input fiber 108 can have two or more cores (e.g., three or more cores, four or more cores, five or more cores, six or more cores, or even more cores). The fiber cores can all have the same cross-sectional shapes, or the cross-sectional shapes of some (or all) of the cores can differ. Further, the fiber cores can all have the same diameter, or some (or all) of the cores can have different diameters.

In certain implementations, the light output surface 108B of the input fiber 108 is planar. In some implementations, the output surface 108B is non-planar. For example, output surface 108B of input fiber 108 can be shaped so that it conforms to the input surface 110A of coupling element 110 to increase the acceptance of light from the input fiber 108 to the input surface 110A. Accordingly, output surface 108B can have a spherical or aspherical curvature to ensure conformity with input surface 110A.

Output fiber 112 can generally have any of the same features and properties as those discussed above in connection with input fiber 108. Typically, the cross-sectional shape and core diameter of output fiber 112 are selected so that measured light is efficiently coupled into output fiber 112 from coupling element 110. In some implementations, the output fiber 112 has the same core diameter and cross-sectional shape as input fiber 108. Alternatively, in certain implementations, output fiber 112 have a different core diameter and/or different cross-sectional shape relative to input fiber 108. As one example, output fiber can be an octagonal fiber with a core diameter of 300 μm.

In some implementations, the light input surface 112A of the output fiber 112 is planar.

In certain implementations, the input surface 112A is nonplanar, and it shaped so that it conforms to the output surface 110B of coupling element 110 to increase the acceptance of light from the coupling element 110 into fiber 112. For example, input surface 112A can be a concave light input surface to conform to the shape of surface 110B.

Alternatively, in some implementations, input surface 112A can be a convex light input surface. A convex input surface 112A can increase the acceptance angle for light passing from coupling element 110 into fiber 112.

As discussed above, in some implementations, the output surface 110B has a spherical shape (e.g., spherical curvature) that defines the output focal position. While the radius r of the output surface 110B can generally have any desired value, it has been discovered that to ensure high scrambling gain, the radius r should be selected based on one or more parameters of the input fiber 108, e.g., the core diameter d and numerical aperture NA of input fiber 108. In certain implementations, it is advantageous if the radius r is determined according to d, NA, and the refractive index n of the material from which coupling element 110 is formed, according to:

$$r = \frac{d ( n - 1 )}{n} \sqrt{\frac{1}{{NA}^{2} - 1}} \approx \frac{d ( n - 1 )}{n \times NA} \qquad ( 1 )$$

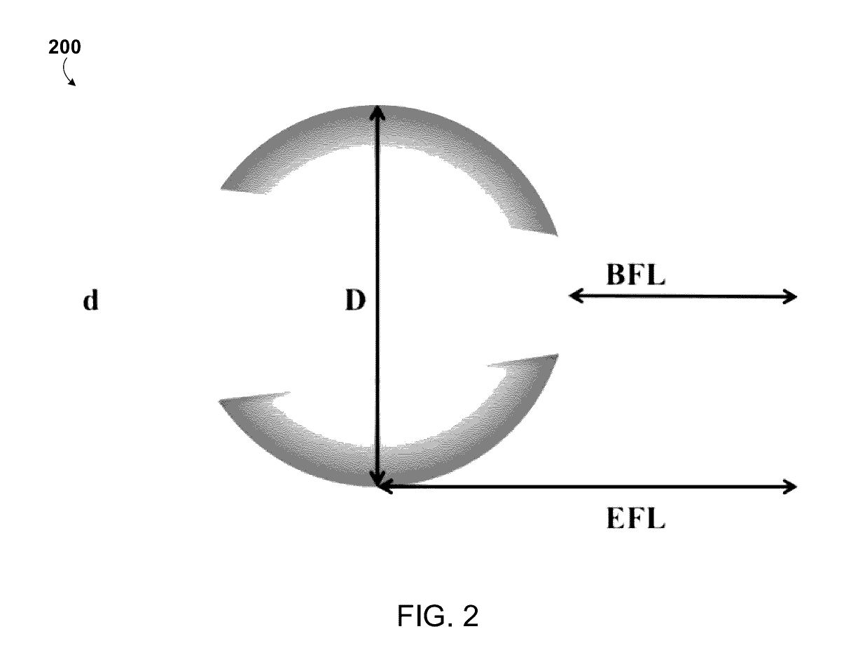

To realize an output surface 110B having a spherical shape, in some implementations, the coupling element 110 can be a (spherical) ball lens. FIG. 2 is a schematic diagram of an optical scrambler based on a ball lens 200. The ball lens 200 can either focus or collimate light according to input source geometry, and acts as a scrambler. The back focal length (BFL) of the ball lens can be calculated from characteristic parameters of the lens as follows:

$$BFL = EFL - \frac{D}{2} , EFL = \frac{nD}{4 ( n - 1 )} \qquad ( 2 )$$

where D is the diameter of the lens, n is the refractive index of the material from which the ball lens is formed, and EFL is the effective focal length of the lens.

It is evident from Equation (2) that when material of n˜2 is used, the BFL goes to zero, irrespective of the diameter D. This implies that for n˜2, high (or even optimum) coupling between coupling element 110 and fibers 108 and 112 can be achieved when the fibers are in direct contact with the lens surface, since the BFL of the lens is located on the lens surface. Such a configuration simplifies overall scrambler design. Moreover, such a configuration mitigates the need to position and control the ball lens at specific distances from the fibers, and the central axes of the ball lens and fibers aligned. Therefore, due to the foregoing advantages that can be realized, in certain implementations coupling element 110 is formed from a material that has a relatively high refractive index n for at least one wavelength within a range from 800 nm to 1300 nm. For example, in some implementations, n is between 1.9 and 2.1 (e.g., between 1.95 and 2.05, larger than 1.95, larger than 1.97) for at least one wavelength within a range from 800 nm to 1300 nm.

As discussed above in connection with FIGS. 1A and 1B, the diameter of the ball lens 200 can be configured to match the core diameters (or effective core diameters) of the input fiber 108 and/or the output fiber 112. By matching the diameter of the ball lens to the core diameters, ball lens 200 functions to effectively exchange the near and far-fields of the fibers, thereby efficiently mixing the modes propagating in these multimode fibers, yielding an increase in instrumental profile stability when making highly sensitive measurements (e.g., radial velocity measurement of exoplanets).

In certain implementations, once the size (e.g., core diameter and NA) of input fiber 108 has been selected the diameter of the ball lens is selected according to:

$$D = \frac{2 d ( n - 1 )}{n} \sqrt{\frac{1}{{NA}^{2} - 1}} \approx \frac{2 d ( n - 1 )}{n \times NA} \qquad ( 3 )$$

While the use of a spherical ball lens provides one implementation of a coupling element 110 having input and output surfaces 110A/B with a spherical shape or curvature, implementation of coupling element 110 as a ball lens is not the only configuration in which at least one of the input and output surfaces have a spherical shape. For example, in some implementations, the coupling element 110 includes a cylindrical body having end surfaces with spherical curvature, such that coupling element 110 is a “pill shaped” element. In certain implementations, coupling element 110 is a half-ball lens with the input surface 110A being planar and the output surface 110B having a spherical shape.

Referring again to FIG. 1B, as used herein, “decentration” refers to the displacement of the optical axis of input fiber 108 or output fiber 112 from the central axis of coupling element 110 in a plane transverse to the central axis of coupling element 110. Decentration can reduce the overall throughput of the optical scrambler. For example, when the input fiber 108 has a core diameter of 300 microns, a 3% loss of light can be observed for ˜10 μm decentration, and an 8% loss of light can be observed for ˜20 μm offset. Accordingly, in some implementations, the central axes of the input fiber 108, the coupling element 110 and the output fiber 112 are displaced from one another by 10 microns or less in a direction perpendicular to the central axes.

In some implementations, to increase transmission or throughput efficiency of the optical scrambler, an anti-reflection coating can be applied to the output surface 110B of the coupling element 110. The anti-reflection coating can be designed for a range of wavelength of interest, e.g., a wavelength range from 0.80 to 1.3 μm. In certain implementations, the anti-reflection coating can also be applied to the output surface 108B of the input fiber 108 and/or to the input surface 112A of the output fiber 112.

In some implementations, optical scrambler 104 further includes a connection fiber (not shown in FIGS. 1A and 1B) optically coupled to an end of the input fiber 108 and/or the output fiber 112. In certain implementations, one end of the connection fiber is coupled to the optical collection system 102 and the other end of the connection fiber is coupled to an input surface of the input fiber 108. Alternatively, one end of the connection fiber can be coupled to an output surface of the output fiber 112 and the other end of the connection fiber can be coupled to the detection system 106. The connection fiber can have a cross-sectional core shape that differs from the cross-sectional core shape of input fiber 108 and/or output fiber 112. The implementation of different core shapes can further increase the overall scrambling gain (discussed further below) of optical scrambler 104. For example, the input fiber 108 and the output fiber 112 can each have an octagonal cross-sectional core shape, and the connection fiber can have a circular cross-sectional core shape.

As discussed above, the effectiveness of optical scrambler 104 can be quantified in terms of the scrambling gain achieved. High scrambling gains are desirable in a variety of applications involving highly sensitive radial velocity measurements, including measurements performed with the Habitable-zone Planet Finder (HPF), a stabilized fiber-fed precision radial velocity spectrograph operating in the near-infrared (NIR) between 0.82 to 1.3 μm, currently being built for the 10 m Hobby-Eberly Telescope (HET). While scrambling is important for any high precision radial velocity instrument, it is particularly important for an instrument on the HET since the fixed-elevation telescope design yields a highly variable entrance pupil relative to other telescopes. Stellar tracking is accomplished by moving a spherical aberration corrector (SAC) and prime focus instrument package (PFIP) over the primary spherical mirror. The actual telescope pupil is therefore defined by the geometric intersection of the SAC, wide-field corrector (WFC) pupil, and the HET primary, and both its orientation and shape change continuously during a track. Without adequate scrambling, the changing pupil introduces large errors in the radial velocity measurements. During a set of observations, these pupil variations may average out over the track as a function of the target elevation and exposure time. Nevertheless, by implementing an optical scrambler that achieves high scrambling gains, the spectrograph PSF can be desensitized to even the most extreme cases of input illumination change.

Scrambling Gain (SG) can be defined as the ratio of the relative displacement of the illumination distribution at the input of an optical element or assembly (such as a fiber) to the relative displacement of the illumination distribution at the output of the element or assembly. For, a fiber,

$$SG = \frac{Δ {d}_{input} / {D}_{input}}{Δ {d}_{output} / {D}_{output}} , \qquad ( 4 )$$

where Δdᵢₙₚᵤₜ is the illumination shift on the fiber, Dᵢₙₚᵤₜ is the fiber diameter, Δdₒᵤₜₚᵤₜ is the measured output centroid shift, and Dₒᵤₜₚᵤₜ is the width of the fiber (for near-field measurements) or the width of the output pupil (for far-field measurements). Several factors influence the minimum scrambling gain required to reach a given velocity precision goal, including telescope guiding precision, spectrograph dispersion, and focal plane sampling. In the case of near-field scrambling (i.e., guiding induced errors) the expected velocity error (σᵥ) is estimated as:

$${σ}_{v} , near \text{-} field = \frac{c}{{R}_{eff}} \frac{Δθ}{θ} \frac{1}{SG} , \qquad ( 5 )$$

where R_{eff} is the effective instrument resolution, JO is the telescope guiding error, θ is the size of the fiber on-sky, and SG is the scrambling gain of the fiber delivery system. Note that for instruments that rely on the use of a slit, R_{eff} is the effective resolution of the slit-less fiber in the detector focal plane: R_{eff}=Rₛₗᵢₜ×(wₛₗᵢₜ/w_{fiber}), where Rₛₗᵢₜ is the slit-limited instrument resolution, wₛₗᵢₜ is the slit width and w_{fiber} is the fiber core diameter.

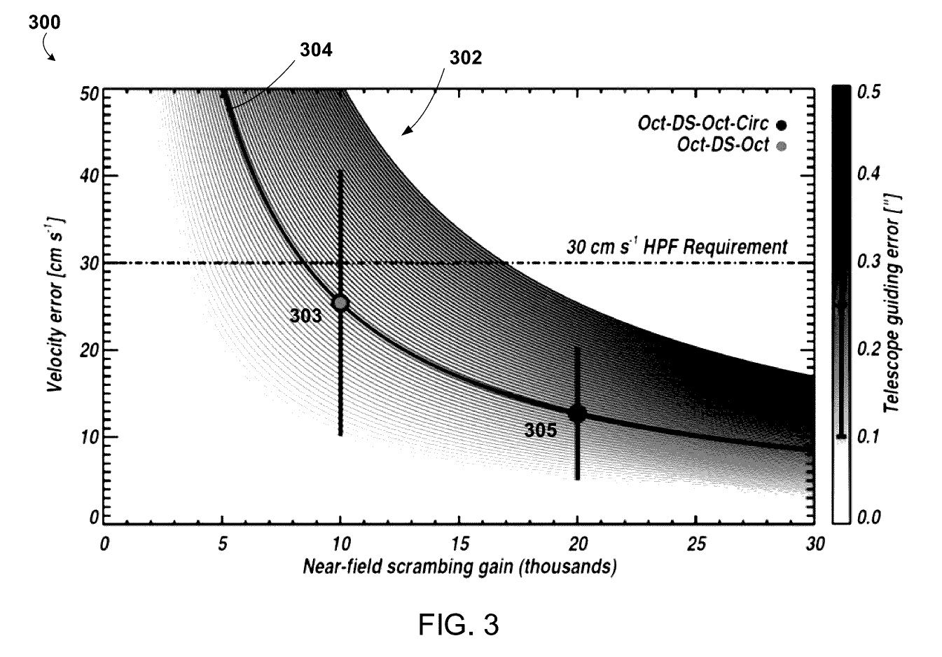

In the case of the HPF spectrograph on HET, with expected guiding precision of 0.25″, 1.7″ fibers on sky (300 μm core diameter), a 100 μm slit, and an operating resolution of 50,000, a scrambling gain of ˜9,000 is required to achieve 30 cm s⁻¹ stability. FIG. 3 shows theoretical guiding-induced velocity error 300 for HPF for a range of guiding precisions. Curves 302 represent different guiding errors. Solid black line 304 is the expected velocity error based on the HET guiding precision (0.25″ RMS). Dots 303 and 305 are theoretical velocity errors associated with the near-field scrambling measurements for measured fiber configurations, which will be discussed in further detail below. Vertical bars show an estimated range of possible guiding precisions for the HET during a given exposure. FIG. 3 shows that scrambling gains above 18,000 can ensure comparable velocity precision even with guiding accuracies as low as 0.5″. This can significantly reduce the risk of having guiding error be a dominant factor in the overall instrument velocity error budget.

The optical scramblers disclosed herein achieve scrambling gains which are significantly higher than scrambling gains that are achieved using conventional scrambling devices. For example, the scramblers can achieve scrambling gains of 15,000 or more (e.g., 16,000 or more, 18,000 or more, 20,000 or more, 22,000 or more, 24,000 or more), which can be a factor of two larger than scrambling gains achieved with conventional scrambling devices.

Alignment of the coupling element 110 and fibers 108 and 112 can be important to ensure high efficiency of the optical scrambler during operation. Classical double scramblers suffer throughput losses of 20-30%. While concentricity between the coupling element and fibers is important for efficient throughput, another important geometrical factor that influences throughput efficiency is the distance between the coupling element 110 and surface 112A of fiber 112. In particular, the coupling element 110 and fiber surface 112A should be maintained at a well-controlled, consistent distance to ensure efficient throughput. By using a coupling element formed from a material having n˜2 and having a spherical light output surface 110B as described above, the BFL for the output surface 110B of the coupling element 110 is typically between 0 μm and 20 μm. Accordingly, the output fiber (e.g., fiber 112) can be butt-coupled to the coupling element 110 to ensure high throughput efficiency.

In general, a variety of different mounting configurations can be used to couple fibers 108 and 112 to coupling element 110 to reduce coupling losses and simplify the alignment of the fibers and coupling element 110. Two such configurations are disclosed below, each of which achieves throughput efficiency of 85-87% efficiency, as measured using NIR fiber lasers, when implemented using anti-reflective (AR) coated ball lenses.

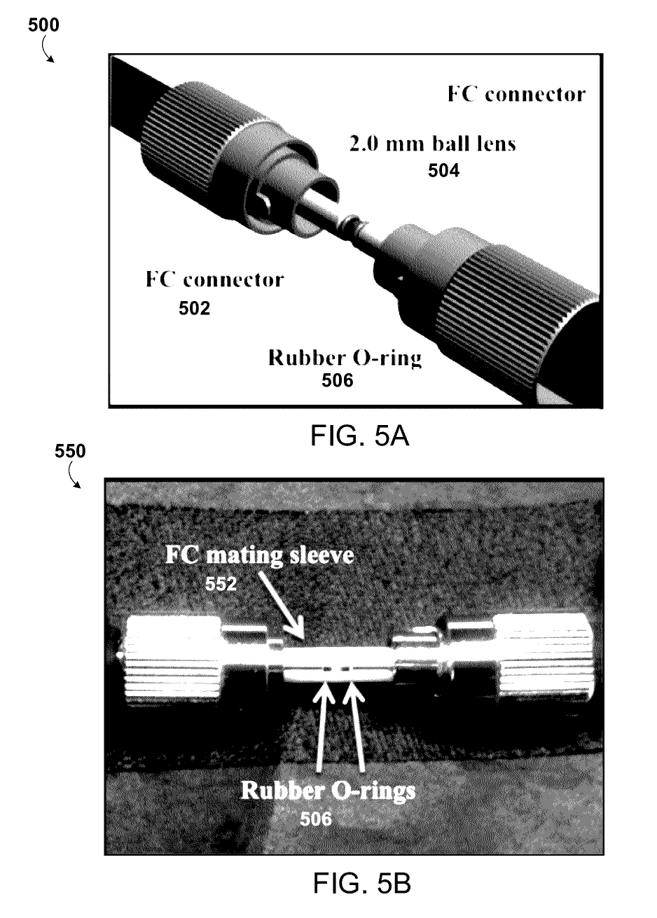

FIG. 5A shows an example mounting configuration 500 using FC connectors 502 for a ball lens-based optical scrambler. The junction can be held together by a ceramic mating sleeve (not shown). FIG. 5B shows a graph 550 of an assembled ball lens-based optical scrambler with octagonal fibers 108 and 112. The mounting configuration shown in FIG. 5A is relatively simple and inexpensive configuration in which a ball lens 504 is held between two small rubber O-rings 506. An outer diameter of the O-rings 506 (e.g., 2.5 mm) matches the ferrule size of the commercially standardized FC/PC fiber connectors 502 used on the fibers, and the entire junction can be placed within an off-the-shelf high-tolerance ceramic split sleeve 552 of inner diameter 2.5 mm. The lens 504 can be naturally maintained in position along the central axis of the fibers by the pressure applied by the mating sleeve 552. In spite of the simplicity of the configuration shown in FIG. 5A, efficiencies close to the theoretical maximum for a perfectly aligned system can be achieved.

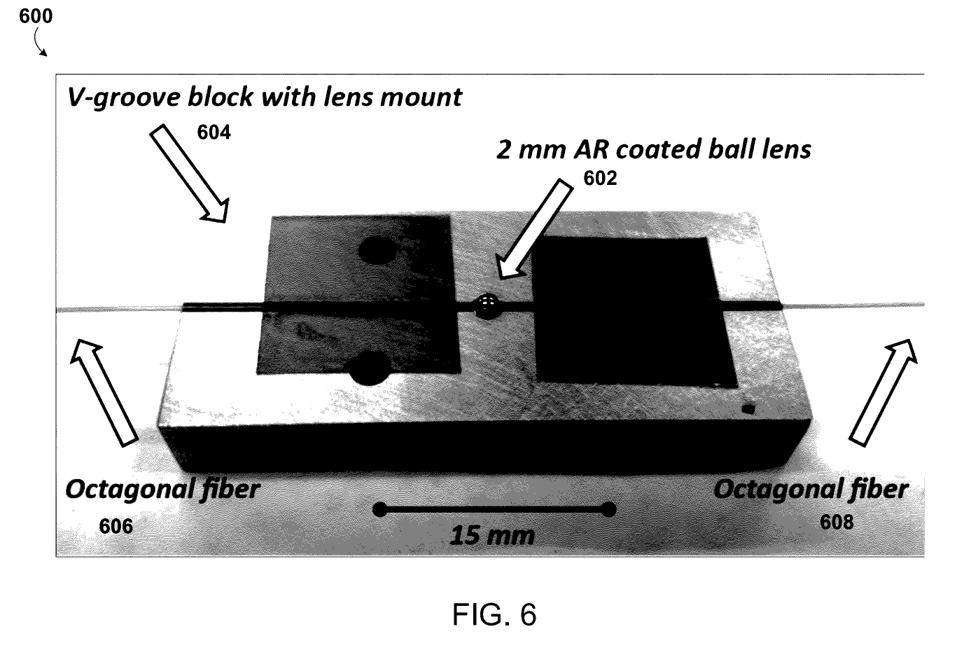

FIG. 6 shows another example mounting configuration 600 using a grooved mounting block. Ball lens 602 is positioned in a beveled groove formed in the center of block 604. Octagonal fibers 606, 608 are positioned within the groove and held in direct contact with the lens 602 on both sides.

In some implementations, block 604 is monolithic and can be used to mount both fibers 606, 608 and the ball lens 602. The fibers can be placed in a groove formed in the block, while the ball is placed in a mount or recess at the center of the block. The block, which is typically formed from a material such as aluminum or stainless steel, can be machined such that three faces can be used as reference indexing surfaces to within a tolerance of, e.g., about 12 μm. In certain implementations, the central axes of each element (input fiber 606, lens 602, output fiber 608) are displaced from one another by 5 μm or less (e.g., 4 μm or less, 3 μm or less, 2 μm or less) in a direction orthogonal to the axis of the groove.

To fabricate block 604, a tapered mounting pocket can be machined on the block surface to secure the coupling element on the center of the block face. A SmartScope™ (available from Optical Gaging Products, Singapore) can be then used to measure the central axis of the mounted coupling element relative to the polished block surface. The microscope measurements are used to determine the location and depth of the fiber groove relative to the block face, ensuring concentricity between the mounted coupling element and the fibers. The groove can be etched using a high precision electric discharge machine or made with a precision 3D printing device. Post-machining, the central axes of the lens and fibers can be measured to ensure concentricity. Polished or cleaved fibers (e.g., octagonal fibers) can be placed in the groove on either side of the coupling element (e.g., a ball lens) and attached to the block with a tape (e.g., Kapton′ tape).

### Ball Lens-Based Optical Scrambler for the HPF Spectrograph

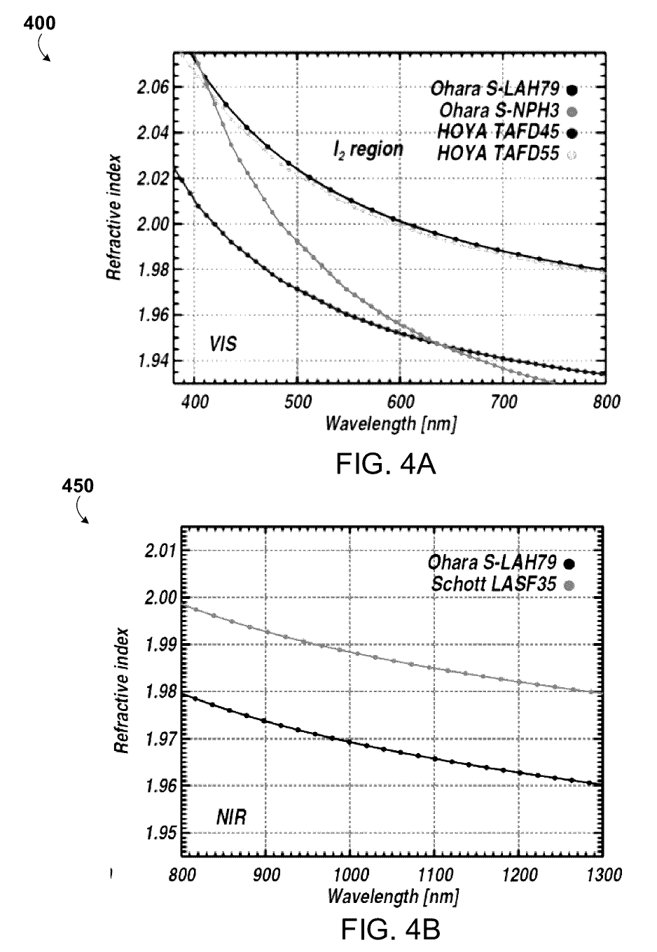

To demonstrate the effectiveness of the optical scramblers disclosed herein, a ball lens-based optical scrambler was constructed for use with the HPF spectrograph discussed above. The material from which the ball lens is fabricated was chosen based on the specific wavelength range of interest. As discussed above, it is advantageous if the material from which the ball lens is formed has a refractive index of n˜2 within the wavelength range of interest, with low dispersion dn/dλ. Certain high-index glasses can cover relatively large wavelength ranges in the visible and NIR with relatively low dispersion. FIGS. 4A-B show refractive index profiles 400 and 450 for a variety of high-index glasses in the visible (FIG. 4A) and near-infrared (FIG. 4B), respectively. For the HPF spectrograph on HET, two high-index glasses, S-LAH79 (Ohara, n=2.00330) and LASF35 (Schott, n=2.02204) can be used.

When selecting the appropriate high-index glass for a particular application, both the refractive index and internal glass transmission are considered to maximize efficiency. The two primary glasses (i.e., S-LAH79 and LASF35) discussed here have high throughput in the NIR (>99% for a 2 mm lens), but have significantly diminished efficiency at wavelengths lower than 400 nm. Certain glasses shown in FIG. 4A do have relatively high transmission (>97%) in the 380-400 nm regime for lens diameters under 1 mm, and would be more appropriate for instruments performing measurements at visible wavelengths.

As discussed above, a suitable diameter (D) for the ball lens can be calculated using Equation (3), as a function of the refractive index of the glass (n), the diameter of the input beam or fiber (d), and the input numerical aperture (NA). The ball lens-based scrambler was designed for a 300 μm fiber fed at f/3.65 at the telescope focal plane, implying a ball lens diameter of ˜2.15-2.17 mm for wavelengths in the near-infrared (NIR) from 0.82-1.3 μm. A ball lens formed from S-LAH79 glass and having a diameter of 2 mm was used in the fabrication of the optical scrambler. It should be noted that in certain implementations, the expected focal ratio exiting the fiber incident on the lens, rather than the native telescope focal ratio, can be used to select the size of the ball lens, which helps to ensure that focal ratio degradation (FRD) and losses due to the lens are relatively low.

For laboratory experiments, centroid values were measured as a proxy for scrambling performance. While this is a reasonable metric for near-field scrambling gains, since near-field illumination centroid drifts will directly manifest as velocity drifts in the focal plane, the direct effect of fiber far-field variation on velocity precision is not as easily quantifiable. In some cases, the degree of far-field output variations for both near and far field input illumination changes can be quantified, but the effect of far-field variations on instrument velocity precision was not calculated, since this calculation is unique to a given instrument. This can be done with accurate ray-tracing of the fiber far-field through the spectrograph optics for a given instrument to set scrambling gain requirements.

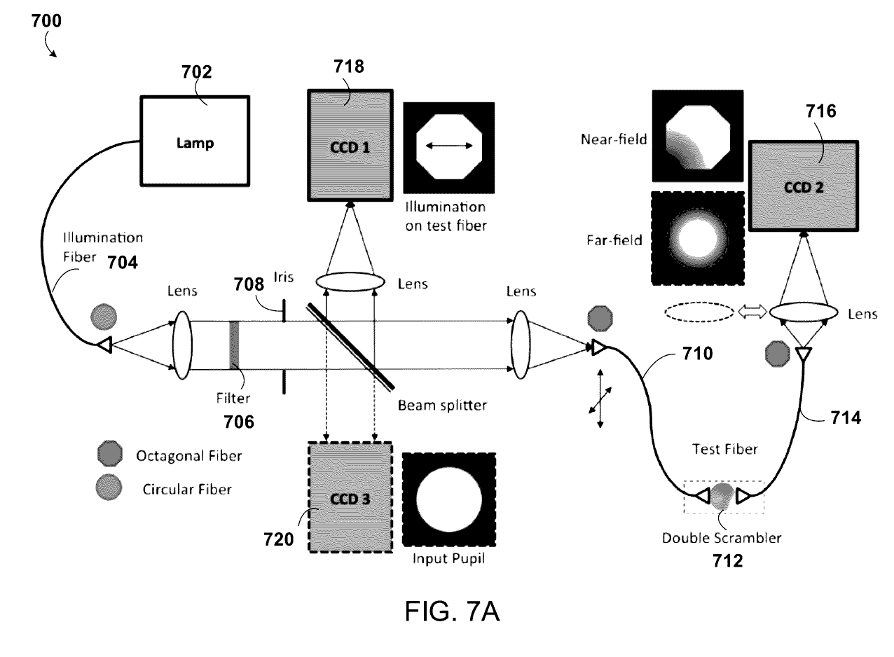

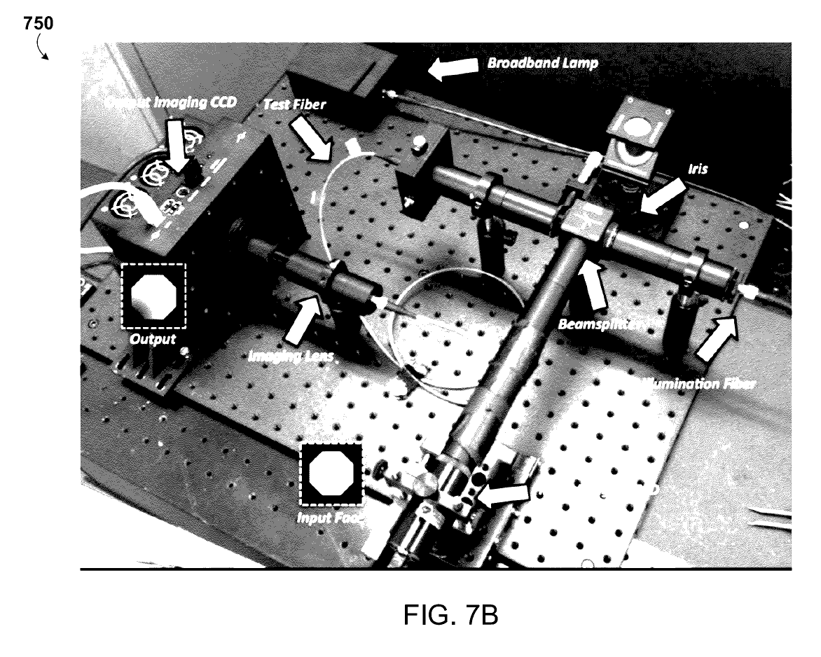

To be sensitive to scrambling gains larger than ˜10,000, a compact laboratory test-stand was designed to maximize measurement stability. FIG. 7A shows a schematic of the apparatus 700 used to measure scrambling gain for a variety of fiber configurations. FIG. 7B shows an image 750 of the scrambling gain measurement apparatus 700 of FIG. 7A. Light from a 50 μm illumination fiber 704 was focused onto a 300 μm test-fiber 710 on an X-Y translation stage at a speed comparable to the HET telescope delivery optics (f/3.65). A broadband Quartz lamp 702 was used for illumination to minimize modal noise effects. Speckle-noise can be the dominant source of measurement error when using narrow-band laser sources. A NIR filter 706 was used to restrict the wavelength coverage to the HPF bandpass (0.8—1.3 μm). An iris 708 was used to precisely control the input numerical aperture of the test fiber 710. A ball lens 712 was used in the optical scrambler to switch between near and far field imaging modes. All optical elements and stages were connected through a series of lens tubes that were all bolted onto a common 2′×2′ optical breadboard. This ensured differential mechanical drift between optical components was reduced. The output of the test fiber 714 was imaged over roughly 500 pixels of a 1024×1024 pixel laboratory CCD 716. A second 400×400 pixel CCD 718 was used to image the fiber input face and measure the location of the illumination spot relative to the fixed illumination fiber 704. A third detector 720 was placed in the pupil plane to measure the input pupil of the test fiber 710. Over typical measurement time-scales (tens of minutes), the measurement apparatus was sufficiently stable to measure scrambling gains of <20,000.

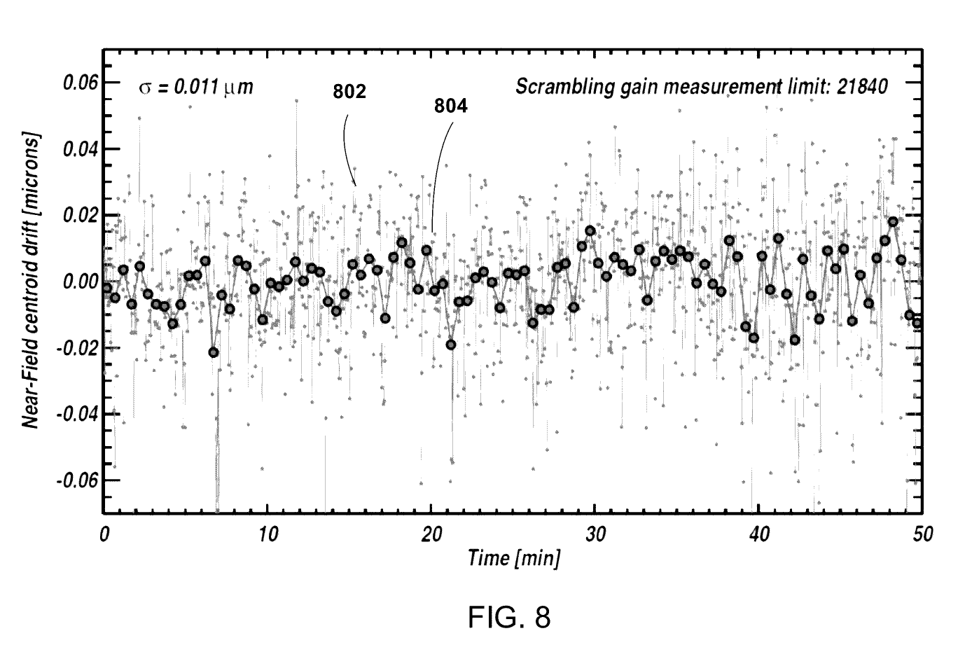

FIG. 8 is a plot showing an example measurement of test fiber output using the measurement apparatus 700 of FIGS. 7A-7B. The input illumination was not moved during measurements. Centroid offset values 802 for individual near-field images are shown as small dots. The vertical axis corresponds to the measured centroid drift in units of microns on the fiber face. Centroid values 804, measured at 30 second intervals, are shown as large dots. The binned RMS stability of the fiber image was 0.011 μm over tens of minutes of uninterrupted measurements, allowing for reliable measurements of scrambling gains <20,000 using apparatus 700.

Optical fibers used for scrambling gain measurements were commercial 300 μm Polymicro products. Octagonal fibers (FBP300/345/380) were connectorized and polished by C Technologies and circular fibers (FIP300/330/370) were terminated and polished by Polymicro. All patch cables were connectorized with standard 2.5 mm FC/PC connectors. Each cable used was roughly 2 m in length. Due to the high degree of FRD in the test fibers, the majority of the incident f/3.65 beam exited the test fiber as a faster f/3.3 beam. This faster beam happened to be well matched to the 2.0 mm ball lens used in the optical scrambler, minimizing any additional FRD due to the ball lens.

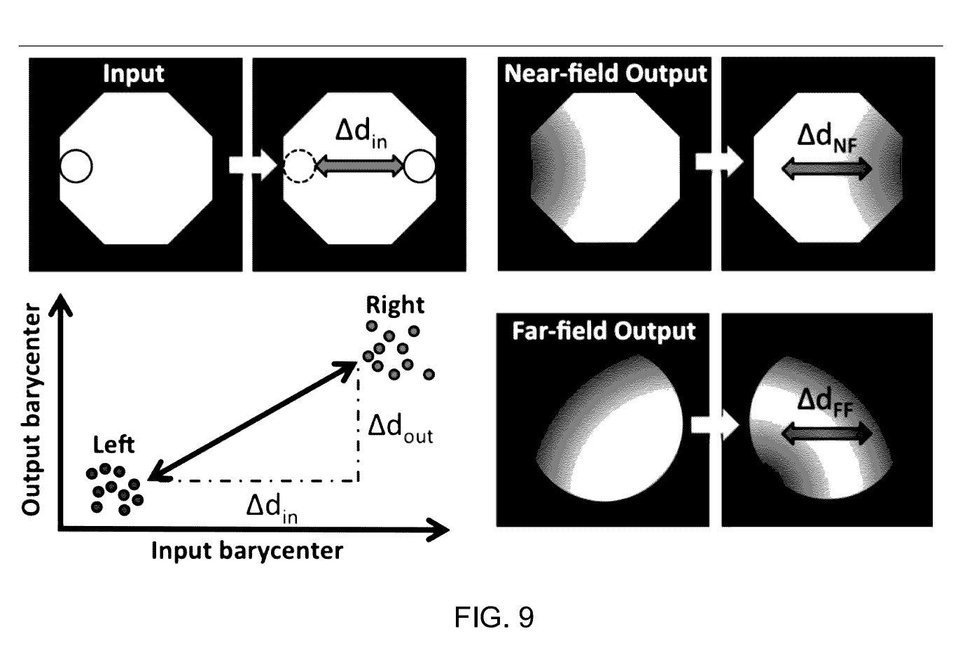

Scrambling measurements were taken by shifting the test fiber input face across a fixed illumination spot and measuring the centroid offset in the fiber output in both near and far fields. The test fiber was shifted by ˜250 μm across the fixed 50 μm near-field illumination. Rather than taking measurements at intermediate points between two edges of the test fiber input, data were taken only at maximum displacement on the fiber face. FIG. 9 shows a schematic diagram of the scrambling measurement method. The test fiber was translated across a fixed illumination spot and the fiber output was recorded at each position. The measured centroid shifts in the fiber near field (NF) and far field (FF) were compared to the distance translated at the input to calculate scrambling gain. Multiple exposure images were recorded at each edge of the test fiber face and averaged. Dark frame and at-field corrections were then applied to the averaged images. An image mask was applied to isolate light coming from only the fiber face.

The centroid of the output fiber illumination was then calculated in both spatial directions and compared to the location of the illumination spot to calculate a formal scrambling gain. Δdᵢₙₚᵤₜ was the distance translated by the focused input illumination and Δdₒᵤₜₚᵤₜ was the measured centroid shift in the fiber output (near- or far-field) along the axis that yielded the largest measurable shift. Output centroid measurements at both illumination positions were used to calculate individual scrambling gain estimates for both the near-field and far-field outputs. The reported scrambling gains were averages of 10 point-to-point scrambling gain measurements.

The foregoing measurement procedure has the benefit of producing the largest measurable output centroid shift over the shortest timescale, thereby minimizing sensitivity to short-term opto-mechanical instabilities in the measurement apparatus. Measurements were repeated along several translation axes on the fiber face to verify results.

The measurements determined only the effect of near-field illumination variation on the near and far-field of the fiber output (i.e., the input pupil incident on the test fiber did not vary). To measure the effect of a varying input pupil on the fiber output, a variable pupil mask can be inserted at the fiber input pupil and rotated, which can be used to probe the extreme case of possible input pupil variation for the HET.

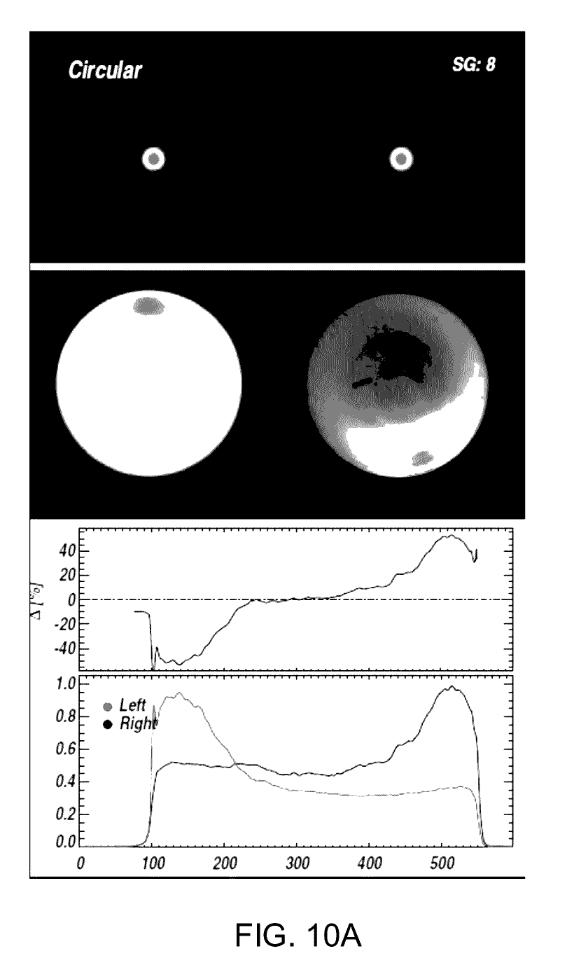

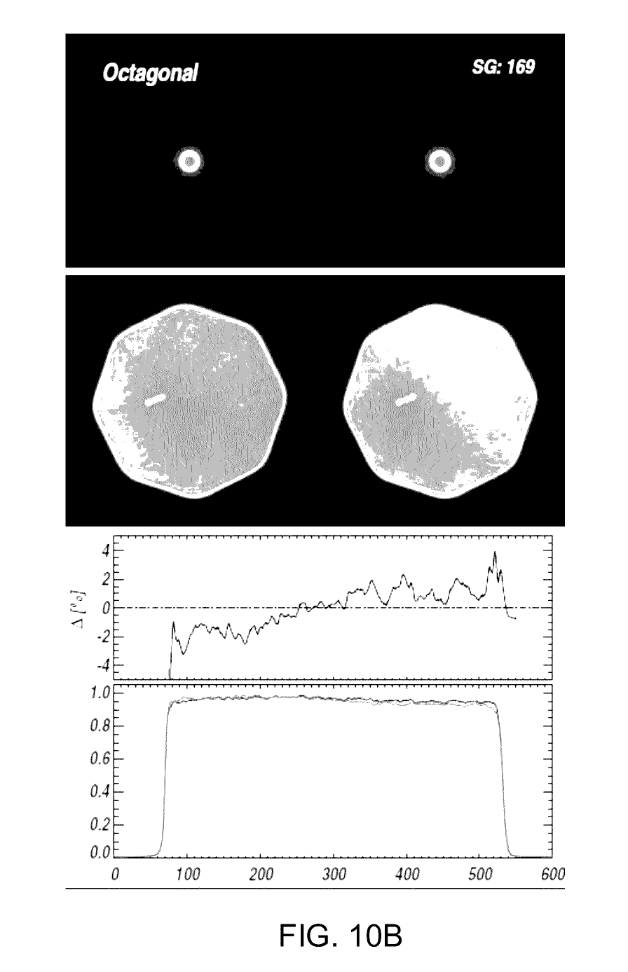

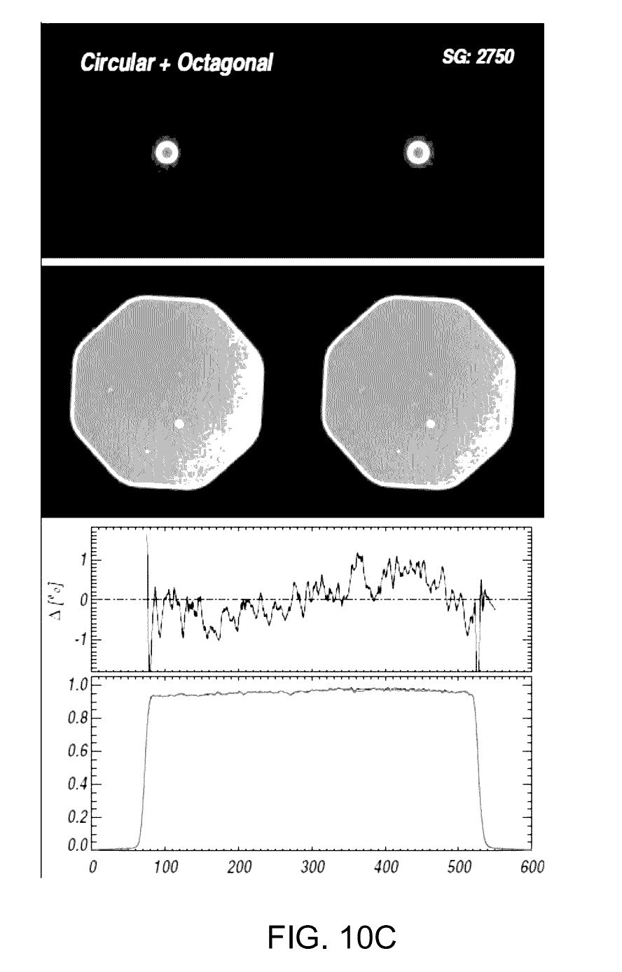

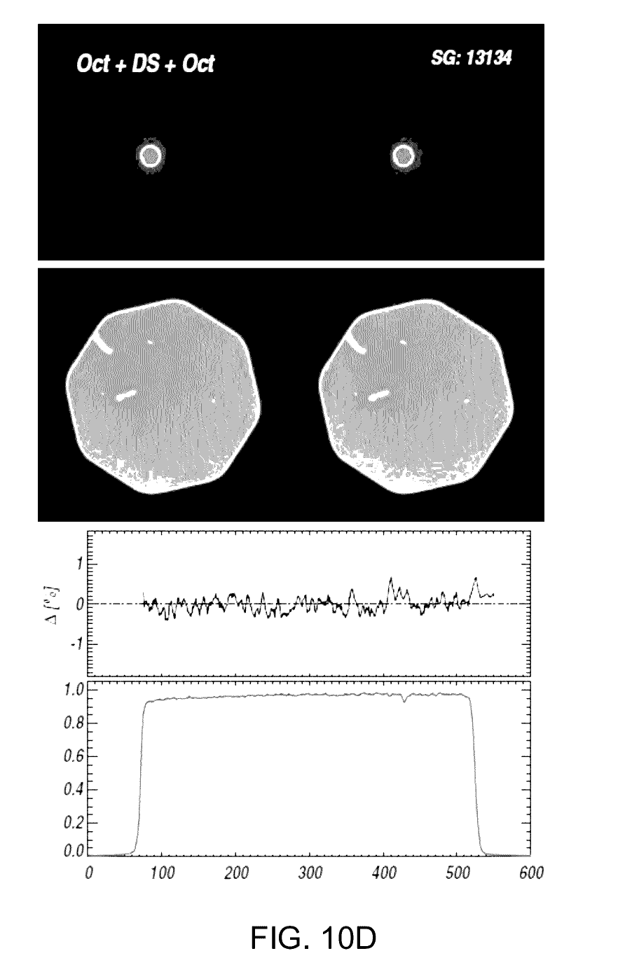

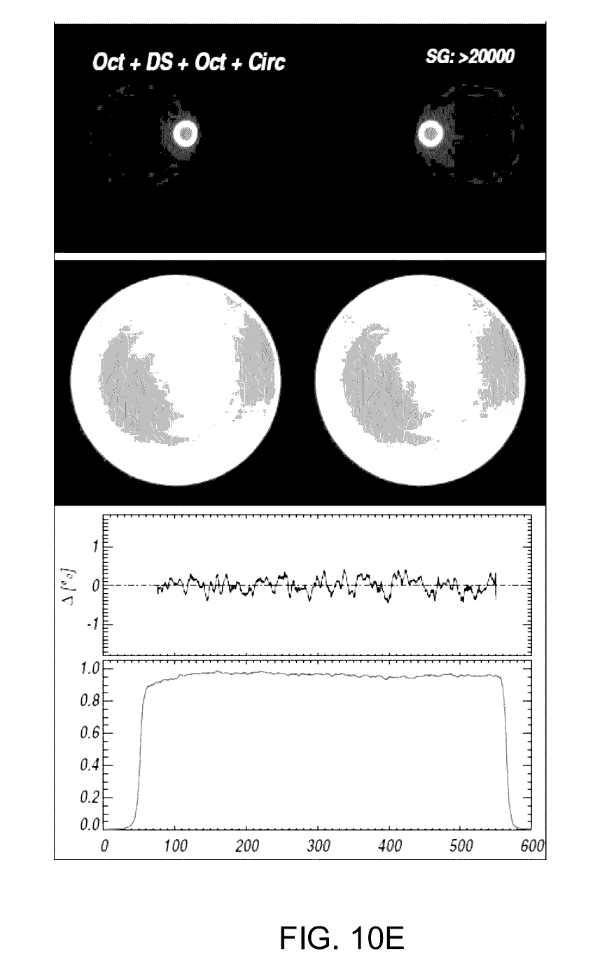

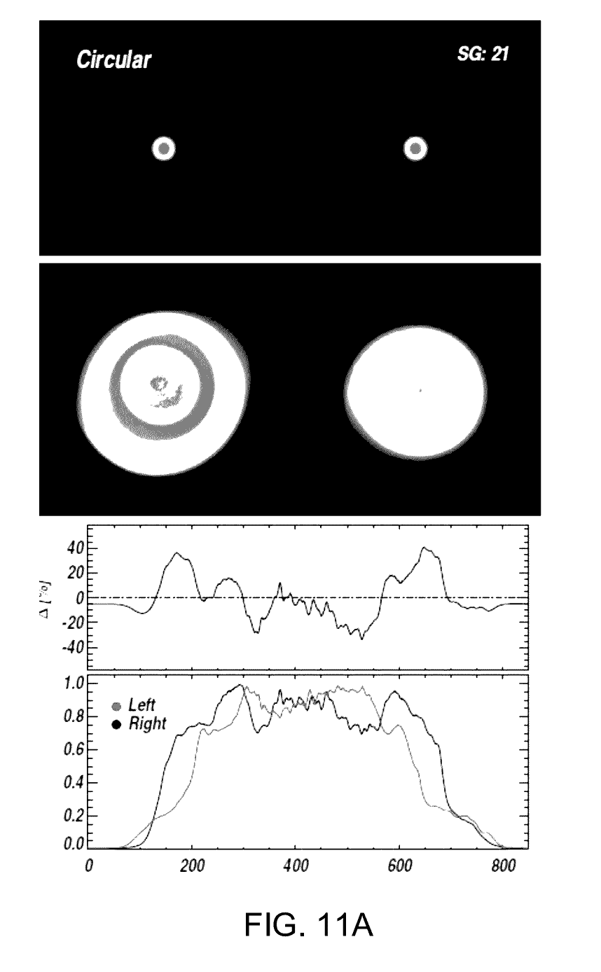

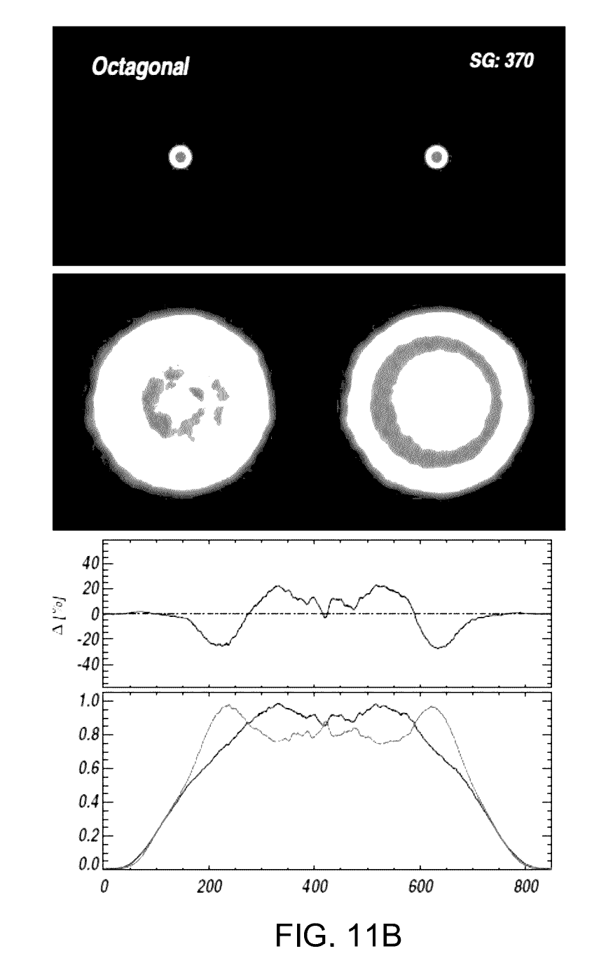

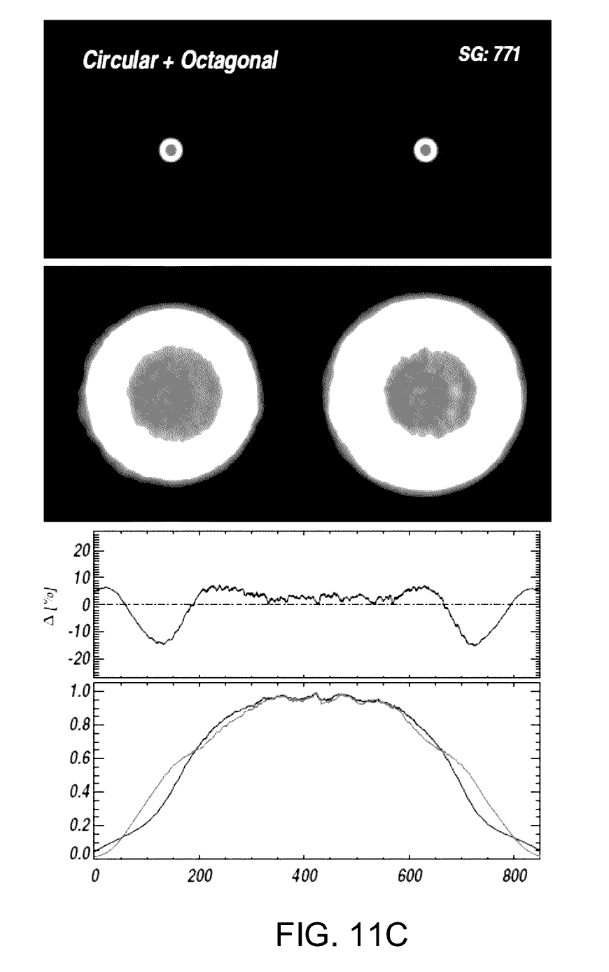

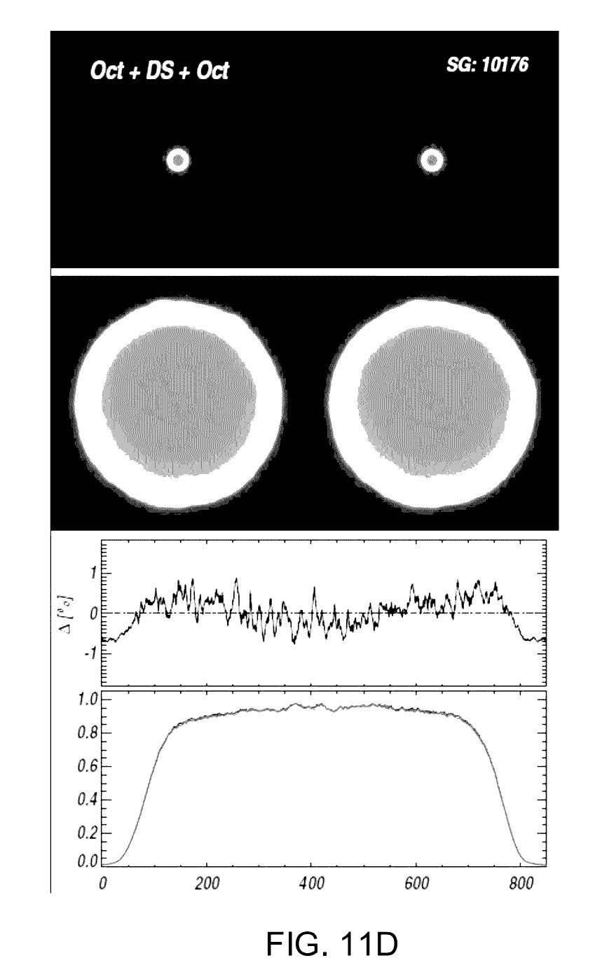

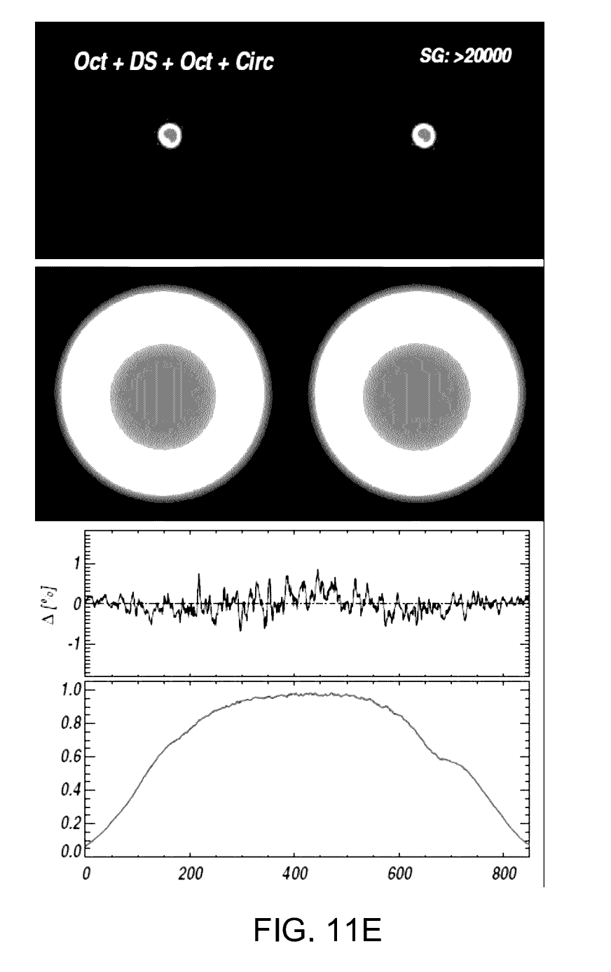

Measurements of scrambling gains for a variety of different fiber configurations are shown in FIGS. 10A-10E and 11A-11E. FIGS. 10A-10E show near-field scrambling measurements for the following fiber configurations: single circular fiber (FIG. 10A), single octagonal fiber (FIG. 10B), input circular fiber+output octagonal fiber (FIG. 10C), input octagonal fiber+optical scrambler+output octagonal fiber (FIG. 10D), and input octagonal fiber+optical scrambler+octagonal fiber+output circular fiber (FIG. 10E). The top panels in each figure show the location of the input face of the test fiber relative to illumination spot. The near-field output images are shown in the middle panels of each figure. Scrambling gains (SG) were calculated by dividing input illumination shift by output centroid drift. The bottom panels in each figure show the 1D intensity distribution along the center of the fiber for the two different illumination positions and the difference (A, in percentage units) between the two 1D intensity distributions. The results for the complete optical scrambler assembly, which includes octagonal fibers (coupled by a ball lens) and a circular fiber, show a stable and uniform output illumination that is significantly desensitized to input illumination variations, as shown in FIG. 10E.

FIGS. 11A-11E show measurements of far-field output patterns as the near-field illumination pattern varied for the following different fiber configurations: single circular fiber (FIG. 11A), single octagonal fiber (FIG. 11B), input circular fiber+output octagonal fiber (FIG. 11C), input octagonal fiber+optical scrambler+output octagonal fiber (FIG. 11D), and input octagonal fiber+optical scrambler+octagonal fiber+output circular fiber (FIG. 11E). The addition of the double-scrambler significantly improved the far-field uniformity and stability, as shown in FIGS. 11D and 11E.

Measured scrambling gains, determined from the measurement results shown in FIGS. 10A-E and 11A-E, are listed in Table 1 for both near and far field outputs, for different fiber configurations.

TABLE 1

| Fiber Configuration | Near-field | Far field |
|---|---|---|
| Circular Fiber | 8 | 21 |
| Octagonal Fiber | 169 | 370 |
| Circular + Octagonal | 2750 | 771 |
| Octagonal + DS + Octagonal | 13,134 | 10,176 |
| Octagonal + DS + Octagonal + | >20,000 | >20,000 |
| Circular | | |

Circular fibers, as expected, yielded relatively low scrambling gains. A single octagonal fiber yielded modest scrambling gains of ˜100-400, consistent with previous measurements. The highest scrambling gain (>20,000) was achieved when using a combination of octagonal fibers, a ball lens-based optical scrambler, and a circular fiber. In this configuration, the circular fiber was coupled to the end of the second octagonal fiber with a standard FC connector mating sleeve. The complete fiber train included, in order of light travel: a first octagonal fiber, a ball lens, a second octagonal fiber, and a circular fiber. The scrambling gain measurements were limited by laboratory apparatus, and it is likely that the true scrambling gains were even higher for this configuration. Nevertheless, the measured near-field scrambling gain translates to a ˜10 cm s⁻¹ velocity shift for HPF, significantly better than the performance goal of 30 cm s⁻¹ guiding-induced velocity error.

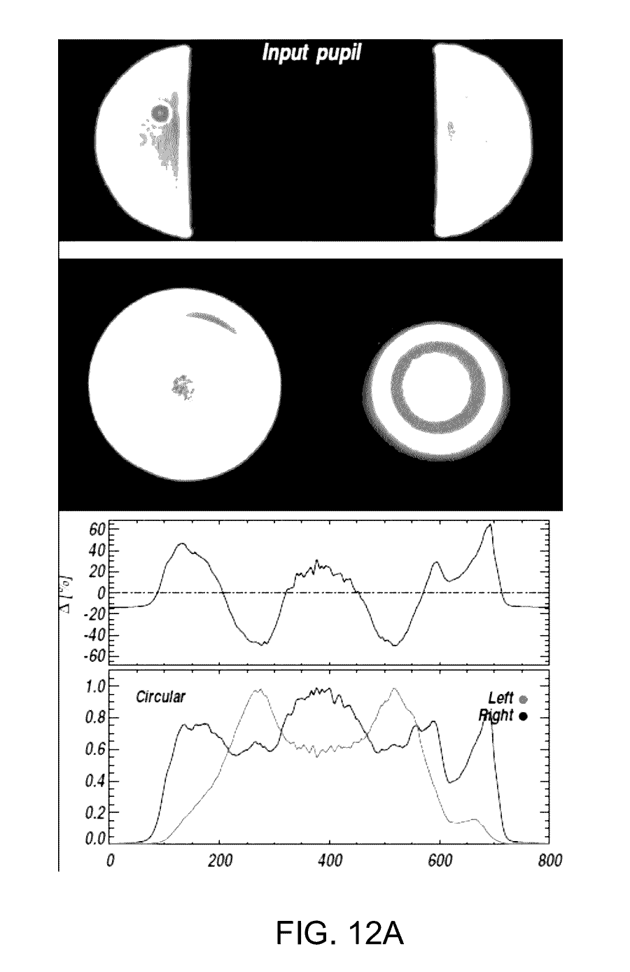

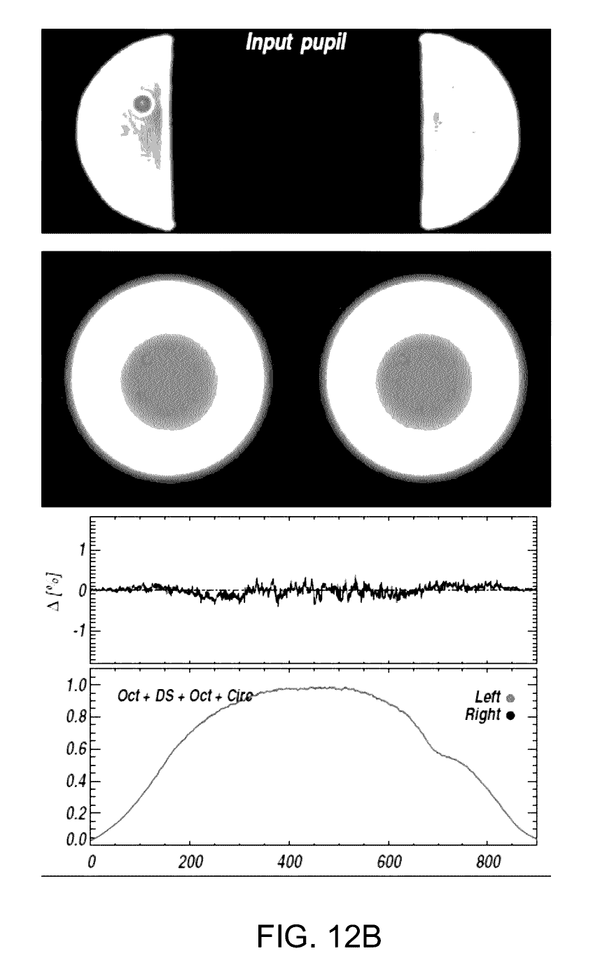

Experiments were also performed to mimic an extreme case of pupil variation. The near-field illumination was kept static (i.e., the illumination spot was fixed with respect to fiber face), but the far field was varied with a rotating aperture mask that obscured half of the input pupil. FIGS. 12A-12B show the measured far-field output of a single circular fiber (FIG. 12A) compared to the fiber configuration that produced the largest scrambling gains, that is, octagonal fiber+optical scrambler+octagonal fiber+circular fiber (FIG. 12B). The upper images in each of FIGS. 12A and 12B show the input pupil to the test fiber. The middle images in each figure show the far-field output of the fiber system, and the lower plots in each figure show the 1D fiber cross-sectional light intensity distribution. While the output from the single circular fiber system changed dramatically (FIG. 12A) to reflect the extreme pupil obscuration imposed at the input, the output from the fiber system with the optical scrambler (FIG. 12B) showed relatively little sensitivity to input pupil illumination variations.

The optical scrambler systems described above yielded high throughput efficiency when coupled to octagonal fibers. Table 2 shows measured efficiencies and laboratory scrambling gains of the optical scrambler systems discussed above. Table 2 also shows measured efficiencies for classical double scrambler systems, which vary between 20-80%, limited mainly by the tight alignment tolerances and intrinsic reflective losses associated with uncoated optical systems.

TABLE 2

| | | Scrambling |
|---|---|---|
| | | Gain |
| Reference/Configuration | Efficiency | (if reported) |
| Hunter et al., PASP 104, 1244 | 20% | — |
| (1992) | | |
| Casse et al., Society of Photo- | 20% | — |
| Optical Instrumentation | | |
| Engineers (SPIE) Conference | | |
| Series, “Optical Telescopes of | | |
| Today and Tomorrow”, Vol. | | |
| 2871, 1187 (1997) | | |
| Avila et al., Society of Photo- | 68% | — |
| Optical Instrumentation | | |
| Engineers (SPIE) Conference | | |
| Series, “Optical Astronomical | | |
| Instrumentation”, Vol. 3355, 900 | | |
| (1998) | | |
| Raskin et al., Society of Photo- | 70% | 1100 |
| Optical Instrumentation | | |
| Engineers (SPIE) Conference | | |
| Series, Vol. 7014, 5 (2008) | | |
| Barnes et al., Society of Photo- | 75% | — |
| Optical Instrumentation | | |
| Engineers (SPIE) Conference | | |
| Series, Vol. 7735, 67 (2010) | | |
| Avila, Society of Photo-Optical | 70% | 6000 |
| Instrumentation Engineers | | |
| (SPIE) Conference Series, Vol. | | |
| 8446, 9 (2012) | | |
| Chazelas et al., Proc. SPIE, Vol. | ~80% | ~10,000 |
| 8450, 845013 (2012) | | |
| Spronck et al., PASP 125, 511 | 65% | — |
| (2013) | | |
| Octagonal + DS + Octagonal | 85% (FC | 13,000 |
| (measured using 830 nm and | connectors | |
| 1310 nm fiber lasers) | with ceramic | |
| | sleeve), | |
| | 87% (V-groove | |
| | mount) | |

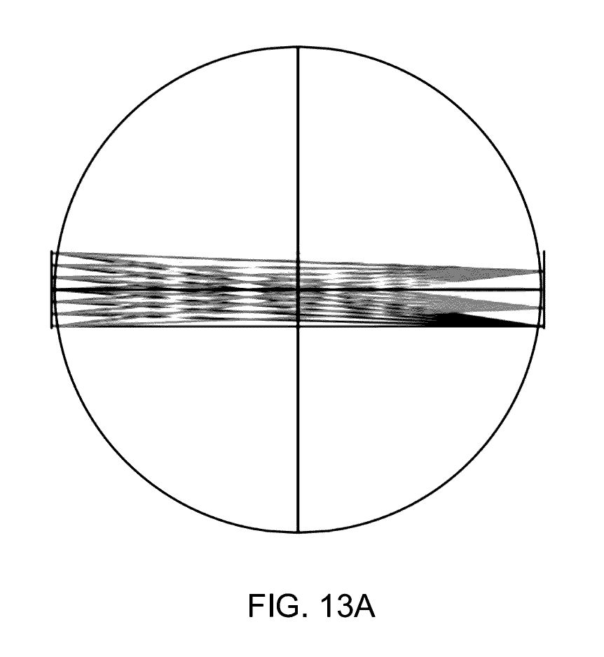

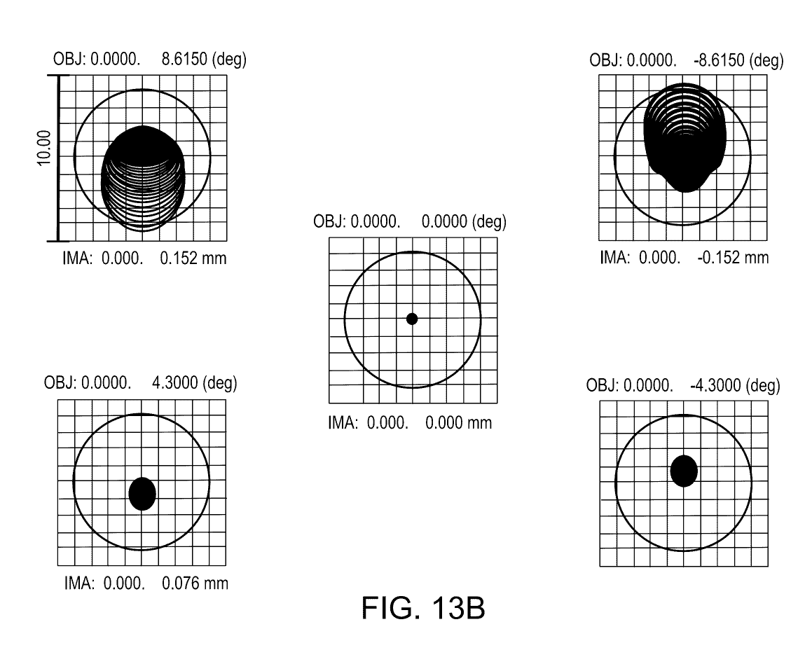

FIG. 13A is a schematic ray tracing diagram of a ball lens. The ball lens receives input light on the left side of the figure, and performs a characteristic conversion from field-to-angle, where the pupil of the first fiber is projected onto the near field of the second fiber, and vice versa. FIG. 13B shows a series of spot diagrams for a variety of different input field points. Spots were generated at a wavelength of 1 μm. The large black circle corresponds to the expected diameter of the Airy disk (8 μm). Consistent with the simulations shown in FIGS. 13A-13B, potential sources of throughput loss were calculated, which include Fresnel reflection, aberrations from the ball lens, diffraction effects, and geometric losses arising from rotational misalignment between the two octagonal fiber faces on either side of the ball lens. A single ball lens element intrinsically has low spherical aberration compared to standard lenses formed from the same material.

As an example, for a fiber core diameter of about 300 microns, it was determined through measurements that the distance between the ball lens and the fiber tip can vary by ˜20 μm without large throughput penalties (<2% loss). In some implementations, decentration between the input and/or output fiber and ball lens can cause significant light loss (3% loss for a 10 μm decentration, 8% loss for a 20 μm decentration). Rotational misalignment of the faces of the two octagonal fibers can cause up to 4% additional loss (2% on average is assumed for efficiency estimation). The light loss due to distance and decentration can change for different fiber core diameters and/or for fixed machining tolerances.

The optical scrambler systems—one of which was coupled using FC connectors, and the other which was coupled using a grooved block—used uncoated 300 μm octagonal input and output fibers, a ball lens with anti-reflective BBAR coating, and a simple alignment scheme, and achieved 85-87% throughput when the systems were illuminated using 830 nm and 1310 nm fiber lasers. The predicted maximum throughput for such a configuration was ˜89% at these wavelengths.

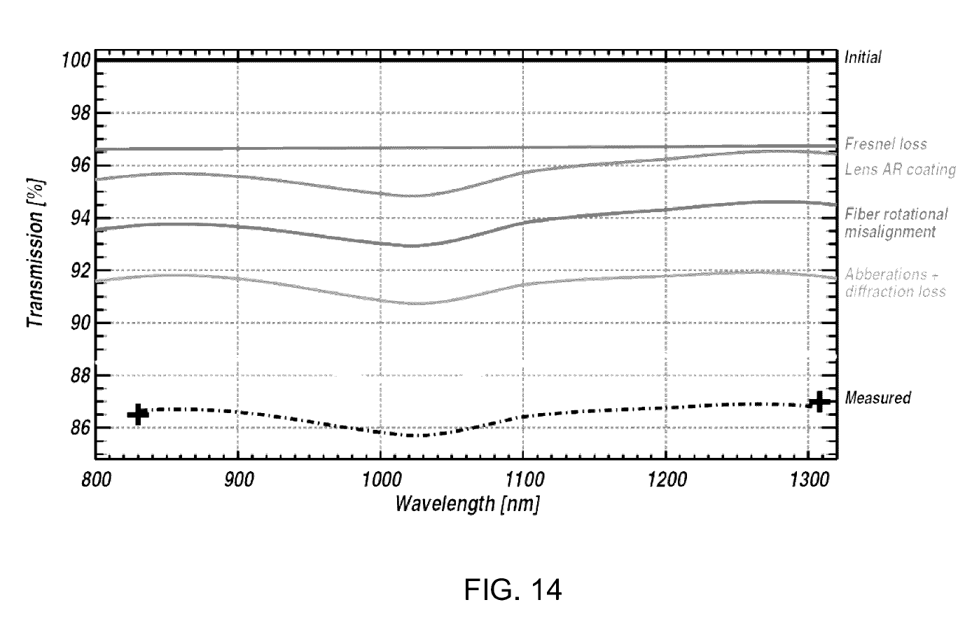

FIG. 14 is a plot showing the theoretical throughput for the optical scrambler system as a function of wavelength (dashed line). The stainless steel FC connectors have typical tolerances of 5 μm between the center of the connector bore and the outer diameter of the ferrule. The optical scrambler has the benefit of rotational alignment ability, as the fibers can be freely rotated inside the mating sleeve to better match octagonal core geometries.

The optical scrambler system connected using a grooved mounting block had improved concentricity due to higher manufacturing tolerances, but did not easily allow for repeatable rotation of the fiber cores. The measured throughput for the optical scrambler system connected using FC connectors could be improved by using custom, tight tolerance (<0.5 μm) ferrules rather than standard commercial connectors to maintain concentricity between the lens and the fiber centers.

With dual-band AR or broadband AR (BBAR) coatings on both the ball lens and the fiber faces, and perfect alignment of the octagonal cores, the theoretical maximum throughput of the optical scrambler systems constructed is approximately 94% for wavelengths from 0.82-1.3 μm. As mentioned above, the inefficiency of conventional optical scramblers has proved to be a deterrent to their use. The high efficiencies of the optical scramblers disclosed herein permits very high scrambling gains to be achieved with a minimal overall throughput penalty.

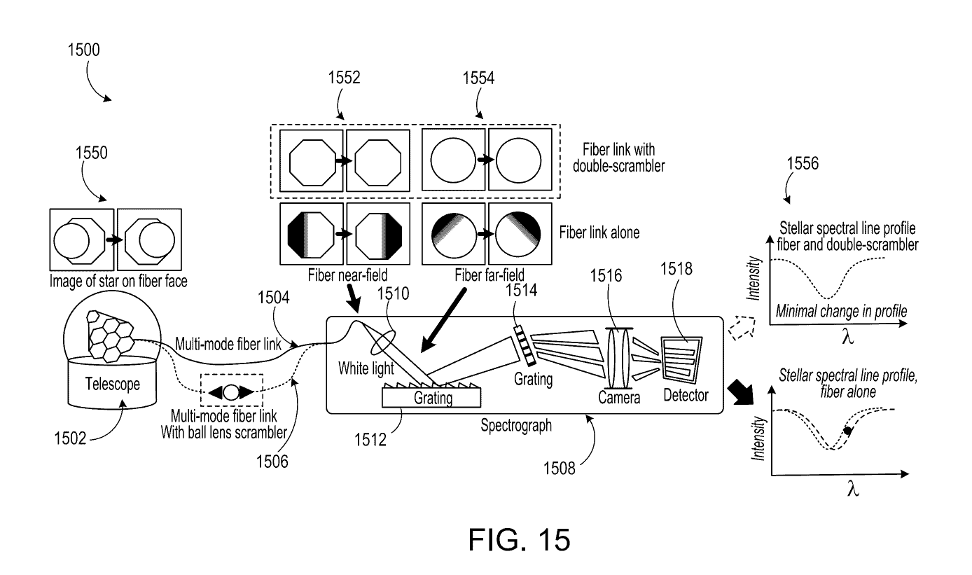

The optical scramblers disclosed herein can be used in a variety of applications and high precision measurement systems, including measurement systems that are used for stellar observation and spectral measurements. FIG. 15 shows a schematic diagram of one example of a stellar spectroscopy system 1500. Light from one or more celestial objects such as stars is collected by a telescope 1502 which delivers the collected light to a multi-mode fiber link. The fiber link can be formed by one or more fibers 1504; alternatively, the fiber link can be formed by one or more fibers connected to an optical scrambler 1506.

The optical scrambler 1506 can be any of the optical scramblers disclosed herein including, for example, a ball lens-based scrambler. The light output from fiber link 1504 or 1506 is measured by a spectrograph 1508, which can include a lens 1510, a first grating 1512, a second grating 1514, a camera 1516, and a detector 1518.

Image 1550 shows an image of light from a star on the input surface of the multi-mode fiber link 1504 or 1506. Lens 1510 converts the fiber near-field image at the output surface of fiber link 1504 or 156 to a far-field image. Image 1552 shows fiber near-field images for fiber link 1504 (bottom images) and 1506 (top images). Image 1554 shows fiber far-field images for fiber link 1504 (bottom images) and 1506 (top images). Plots 1556 show spectral line intensity profiles for fiber link 1504 (bottom plot) and 1506 (top plot).

As the distribution of light from the star on the input surface of fiber links 1504 and 1506 varies with telescope guiding precision and atmospheric effects, the output of the multi-mode fiber link 1504 varies in both near and far-fields. This has a marked effect on the recorded spectra, degrading measurement precision. However, for multi-mode fiber link 1506, the effect is significantly reduced, and the spatial light distribution at the entrance to the spectrograph (i.e., at the output surface of fiber link 1506) is essentially decoupled from variations in the spatial input illumination distribution, enabling significantly higher precision in measurement results.

The optical scramblers disclosed herein can be used with a variety of fiber-fed measurement systems, to provide effective scrambling of both fiber near- and far-field spatial light distributions, while maintaining high throughput efficiency straightforward assembly and alignment. In addition to use with the near-infrared Habitable-zone Planet Finder spectrograph on the 10-m Hobby Eberly Telescope, the optical scramblers can be used with other current and future fiber-fed precision radial velocity spectrographs such as the CARMENES, MINERVA, NRES, and PARAS spectrographs. More generally, the optical scramblers disclosed herein can be used with any high precision measurement system that benefits from decoupling the input illumination distribution from the illumination distribution at the entrance to a spectrometer or other measurement device.

### OTHER IMPLEMENTATIONS

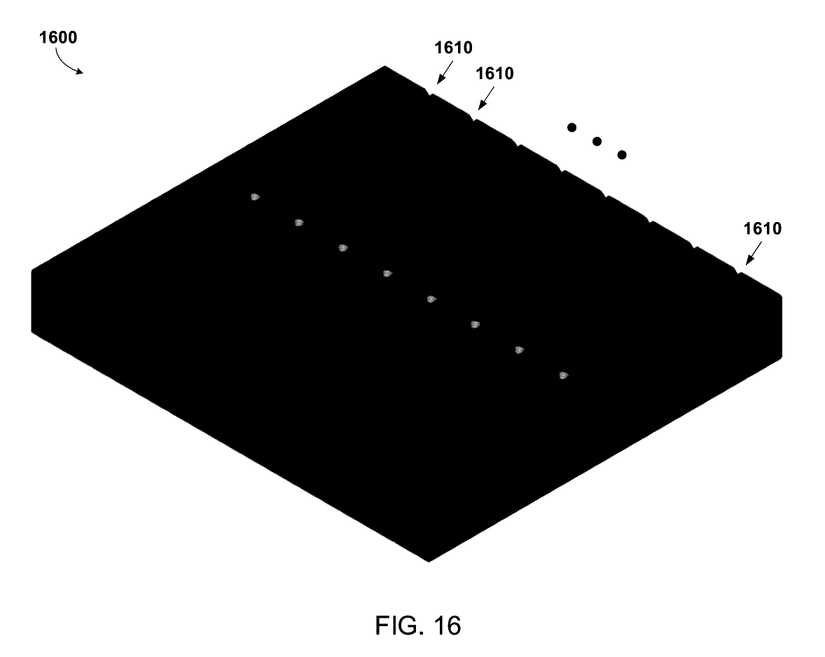

It is to be understood that the foregoing description is intended to illustrate and not limit the scope of the disclosure, which is defined by the appended claims. For example, an optical scrambler can include a number of units each having an optical coupling element (e.g., a ball lens), a first fiber, and a second fiber. The number of units can be integrated on a mounting block. As illustrated in FIG. 16, a mounting block 1600 includes a number of groove channels 1610. Each groove channel can be similar to the V-groove block 604 of FIG. 6. Each groove channel can be configured to support a respective first fiber, a respective coupling element, and a respective second fiber to maintain a respective fixed spacing between the respective first and second fibers and the respective coupling element. The groove channels can be parallel to each other. Other aspects, advantages, and modifications are within the scope of the following claims.

What is claimed is:

1. An optical scrambler comprising:
a first fiber configured to receive measured light from an optical collection system;
a second fiber configured to deliver the measured light to a detection system; and
an optical coupling element positioned between a light output surface of the first fiber and a light input surface of the second fiber and configured to deliver the measured light from the first fiber to the second fiber,
wherein the coupling element defines an output focal position for the measured light that is delivered to the second fiber and the output focal position is located within 50 microns of an output surface of the coupling element.

2. The optical scrambler of claim 1, wherein the output surface of the coupling element has a spherical shape that defines the output focal position.

3. The optical scrambler of claim 2, wherein a radius of the output surface is determined based on one or more parameters of the first fiber including a core diameter and numerical aperture.

4. The optical scrambler of claim 1, wherein the output focal position is at the output surface of the optical coupling element.

5. The optical scrambler of claim 1, wherein the light input surface of the second fiber is within 50 microns of the output focal position.

6. The optical scrambler of claim 5, wherein the light input surface of the second fiber is at the output focal position.

7. The optical scrambler of claim 1, wherein the light input surface of the second fiber is positioned in contact with the output surface of the coupling element.

8. The optical scrambler of claim 1, wherein the coupling element has an input surface with a spherical shape that defines an input focal position.

9. The optical scrambler of claim 8, wherein the light output surface of the first fiber is within 50 microns of the input focal position.

10. The optical scrambler of claim 9, wherein the light output surface of the first fiber is at the input focal position.

11. The optical scrambler of claim 1, wherein the light output surface of the first fiber is positioned in contact with an input surface of the coupling element.

12. The optical scrambler of claim 1, wherein the coupling element comprises a ball lens.

13. The optical scrambler of claim 1, wherein the coupling element is formed from a material having a refractive index of between 1.9 and 2.1 for at least one wavelength within a range from 400 nm to 1300 nm.

14. The optical scrambler of claim 13, wherein the light input surface of the second fiber is within 50 microns of the output focal position.

15. The optical scrambler of claim 13, wherein the coupling element has an input surface with a spherical shape that defines an input focal position, and wherein the light output surface of the first fiber is within 50 microns of the input focal position.

16. The optical scrambler of claim 13, wherein the material has a refractive index of between 1.95 and 2.05 for at least one wavelength within the range from 400 nm to 1300 nm.

17. The optical scrambler of claim 1, wherein the coupling element comprises a cylindrical body having end surfaces with spherical curvature.

18. The optical scrambler of claim 1, wherein the output surface of the coupling element has an aspherical curvature.

19. The optical scrambler of claim 1, wherein the first fiber is a multimode fiber with a core diameter within 50 microns to 1000 microns, and wherein the second fiber is a multimode fiber with a core diameter within 50 microns to 1000 microns.

20. The optical scrambler of claim 1, wherein the first fiber has an octagonal cross-sectional shape, and wherein the second fiber has an octagonal cross-sectional shape.

21. The optical scrambler of claim 1, wherein the light input surface of the second fiber is nonplanar and has a shape that conforms to the output surface of the coupling element.

22. The optical scrambler of claim 1, wherein the coupling element comprises an input surface through which the measured light enters the coupling element, and wherein the light output surface of the first fiber is nonplanar and has a shape that conforms to the input surface of the coupling element.

23. The optical scrambler of claim 1, further comprising a third fiber optically coupled to at least one of the first fiber and the second fiber.

24. The optical scrambler of claim 23, wherein the first and second fibers each have an octagonal cross-sectional shape and the third fiber has a circular cross-sectional shape.

25. The optical scrambler of claim 1, further comprising a mounting apparatus comprising at least one channel configured to support the first fiber, the coupling element, and the second fiber to maintain a fixed spacing between the first and second fibers and the coupling element.

26. The optical scrambler of claim 25, wherein the mounting apparatus comprises a groove mounting block fabricated using a 3D printing or Stereolithographic system.

27. The optical scrambler of claim 1, further comprising a mounting block comprising a plurality of groove channels each configured to support a respective first fiber, a respective coupling element, and a respective second fiber to maintain a respective fixed spacing between the respective first and second fibers and the respective coupling element.

28. The optical scrambler of claim 1, further comprising a first fiber connector coupled to an end of the first fiber comprising the light output surface of the first fiber, and a second fiber connector coupled to an end of the second fiber comprising the light input surface of the second fiber, wherein the coupling element is positioned between the first fiber connector and the second fiber connector.

29. The optical scrambler of claim 1, wherein during operation, the optical scrambler provides a scrambling gain of 10,000 or more for the measured light.

30. A radial velocity measurement system comprising:
an optical collection system for collecting light from a moving object;
a detection system; and
the optical scrambler of claim 1.
